(19) United States
(12) Patent Application Publication
(10) Pub. No.: US 2025/0392131 A1
(43) Pub. Date: Dec. 25, 2025

(54) MULTI-PORT FLEXIBLE INTERCONNECTION DEVICE FOR DISTRIBUTION NETWORKS, AND CONTROL METHOD AND SYSTEM THEREOF

(71) Applicant: SHANGHAI JIAO TONG UNIVERSITY, Shanghai (CN)

(72) Inventors: Jianwen ZHANG, Shanghai (CN); Jianqiao ZHOU, Shanghai (CN); Gang SHI, Shanghai (CN); Xu CAI, Shanghai (CN); Haohua PENG, Shanghai (CN); Kejing LIANG, Shanghai (CN)

(73) Assignee: SHANGHAI JIAO TONG UNIVERSITY, Shanghai (CN)

(21) Appl. No.: 18/995,879

(22) PCT Filed: Feb. 7, 2023
(86) PCT No.: PCT/CN2023/074774

§ 371 Date: Jan. 17, 2025

(30) Foreign Application Priority Data
Jul. 19, 2022 (CN) 202210850306.0

(51) Int. Cl. H02J 3/24; G05B 11/42

(52) U.S. Cl. CPC H02J 3/24; G05B 11/42

(57) ABSTRACT

A multi-port flexible interconnection device for distribution networks, and a control method and system thereof are provided. The multi-port flexible interconnection device includes a bipolar output inverter and a multi-port flexible interconnection module connected in series therewith. The multi-port flexible interconnection module includes multiple unipolar output inverters which share the same common connection bus and are connected in parallel, and AC output ports of each unipolar output inverter are interconnected with different feeders. By adjusting an AC output voltage in series between the feeders, active and reactive power decoupling control for each feeder is achieved. Energy balance for the entire device and its components is maintained by controlling an internal circulating current of the bipolar output inverter. The provided introduces the multi-port flexible interconnection module to interconnect multiple feeders in a distribution network, enabling flexible power interchange between feeders and facilitating a flexible AC distribution network featuring multi-terminal interconnection.

### CROSS-REFERENCE TO THE RELATED APPLICATIONS

This application is the national phase entry of International Application No. PCT/CN2023/074774, filed on Feb. 7, 2023, which is based upon and claims priority to Chinese Patent Application No. 202210850306.0, filed on Jul. 19, 2022, the entire contents of which are incorporated herein by reference.

### TECHNICAL FIELD

The present invention relates to the technical field of flexible interconnection of distribution networks and power electronics, in particular to a multi-port flexible interconnection device for distribution networks, and a control method and system thereof.

### BACKGROUND

The traditional AC power grid has significant advantages in system stability and reliability. However, with the rapid development of the economy and society, electricity demand continues to increase, highlighting the issue of uneven feeder loads. The control capability of traditional distribution networks proves inadequate, failing to effectively address problems such as feeder congestion. As a result, the actual operating capacity of the distribution system is often limited by the feeders that reach their capacity limits first, which is frequently much lower than the designed capacity of the distribution network, severely impacting its economic efficiency.

On the other hand, with the growing severity of global warming and environmental pollution, the development of renewable energy sources such as wind and solar power has become a global consensus. As distributed energy sources, wind and solar power exhibit characteristics such as intermittency, uncertainty, and volatility, which can exacerbate problems like voltage violations and bidirectional power flows when integrated into the grid. This poses significant technical challenges for distribution networks in terms of voltage control, transient stability, and oscillation damping.

The mainstream topology of existing flexible interconnection devices primarily utilizes back-to-back voltage source inverters, formed by multiple voltage source inverters connected through a shared DC bus. This configuration allows for multi-directional power flow and decoupled control of active and reactive power. However, this topology relies on full-power voltage source inverters, which results in high costs, large size, significant footprint, and high losses.

### SUMMARY

This section aims to outline certain aspects of the embodiments of the present invention and to briefly introduce some preferred embodiments. Simplifications or omissions may be made in this section and the abstract and title of the application to avoid obscuring the purpose of these elements. Such simplifications or omissions should not be interpreted as limiting the scope of the present invention.

In light of the aforementioned existing issues, the present invention is proposed.

The present invention provides a multi-port flexible interconnection device for distribution networks, and a control method and system thereof, which can effectively address issues such as exacerbated voltage violations, bidirectional power flows, load imbalances, network congestion, and high network losses during grid connection.

To address the aforementioned technical issues, the present invention provides the following technical scheme. A series-parallel multi-port flexible interconnection device with active power flow control capability for distribution networks comprises:
a bipolar output inverter and a multi-port flexible interconnection module connected in series therewith, wherein
the bipolar output inverter features bipolar output voltage and reactive power interchangeability, so as to absorb reactive power from a system or provide reactive power to the system;
the multi-port flexible interconnection module comprises multiple unipolar output inverters which share the same common connection bus and are connected in parallel, AC output ports of the unipolar output inverters are interconnected with feeders, and by adjusting the amplitude and phase of an AC output port voltage of the unipolar output inverters connected in series between the feeders, active control of active and reactive power of the feeders is achieved; and an AC component of the AC output port voltage of the unipolar output inverters connected in series between the feeders is defined as a power flow regulation equivalent voltage, and the multi-port flexible interconnection module is defined as a power flow regulation module.

As a preferable scheme of the series-parallel multi-port flexible interconnection device with active power flow control capability for distribution networks provided by the invention,
the power flow regulation module comprises a second unipolar output inverter connected in parallel with the unipolar output inverters, and the second unipolar output inverter enables the connection between the bipolar output inverter and feeder-side unipolar output inverters; and by adjusting the frequency, amplitude, and phase of an AC output port voltage of the second unipolar output inverter, circulating current is injected into the bipolar output inverter, stabilizing a voltage of the common connection bus of the power flow regulation module.

As a preferable scheme of the series-parallel multi-port flexible interconnection device with active power flow control capability for distribution networks provided by the invention,
a topology of the unipolar output inverter or the second unipolar output inverter in the power flow regulation module is a two-level half-bridge inverter, a three-level half-bridge inverter, or any other unipolar output inverter which allows for bidirectional power flow, or a modular multilevel single-phase current converter.

As a preferable scheme of the series-parallel multi-port flexible interconnection device with active power flow control capability for distribution networks provided by the invention,
a topology of the bipolar output inverter is a two-level full-bridge inverter, a three-level full-bridge inverter, or any other bipolar output inverter which allows for bidirectional power flow, or a cascaded bipolar output inverter with submodules employing two-level or three-level full-bridge topologies.

The invention also provides the following technical scheme. A control method of the series-parallel multi-port flexible interconnection device comprises: a line power flow control loop, a bipolar output inverter control loop, and a common connection bus voltage balance control loop, wherein
in response to the series-parallel multi-port flexible interconnection device being interconnected with multiple feeders, the active power magnitude of one and only one feeder is determined by the active power balance requirements of a system, only the reactive power magnitude of the said feeder needs to be controlled, and the said feeder is referred to as a constant reactive power control feeder; for the other feeders, both active power and reactive power need to be controlled, referred to as power flow control feeders; and
a phase-locked loop locks onto a three-phase phase voltage at the nodes of the constant reactive power control feeder, and a phase angle output from the phase-locked loop provides an angle for the Park's transformation matrix from an abc coordinate system to a dq coordinate system.

As a preferable scheme of the control method of the series-parallel multi-port flexible interconnection device provided by the invention, the control objective of the line power flow control loop is to ensure that the active power of the power flow control feeder reaches a reference value

$${P}_{j}^{*}$$

and the reactive power reaches a reference value

$${Q}_{j}^{*} ;$$

the control objective of the bipolar output inverter control loop is to ensure that the reactive power of the constant reactive power control feeder reaches a reference value

$${Q}_{i}^{*}$$

and the sum of three-phase capacitor voltages of the bipolar output inverter is stabilized at a reference value

$$\sum {V}_{SM}^{*}$$

and an output thereof is a reference value

$${\vec{V}}_{p}^{*}$$

of an AC component of a voltage at an AC output port of the bipolar output inverter; and
the control objective of the common connection bus voltage balance control loop is to stabilize three-phase common connection bus voltages at a reference value

$${V}_{l i n k}^{*} .$$

As a preferable scheme of the control method of the series-parallel multi-port flexible interconnection device provided by the invention, an output of the line power flow control loop is

$$Δ {\vec{V}}_{ij}^{{}_{{}_{*}}} = {\vec{V}}_{Ci}^{{}_{{}_{*}}} - {\vec{V}}_{Cj}^{{}_{{}_{*}}}$$

where

$${\vec{V}}_{Ci}^{{}_{{}_{*}}}$$

is a reference value of an AC component of an output voltage at an AC output port of the unipolar output inverter connected to the constant reactive power control feeder,

$${\vec{V}}_{Cj}^{{}_{{}_{*}}}$$

is a reference value of an AC component of an output voltage at an AC output port of the unipolar output inverter connected to the power flow control feeder, the subscript i indicates an i^{th} feeder as the constant reactive power control feeder, and the subscript j denotes a j^{th} power flow control feeder.

As a preferable scheme of the control method of the series-parallel multi-port flexible interconnection device provided by the invention, the bipolar output inverter control loop consists of a voltage control outer loop, a reactive power control outer loop, and a current control inner loop.

The invention also provides the following technical scheme. A control method for balancing phase-to-phase voltages of the bipolar output inverter in the series-parallel multi-port flexible interconnection device comprises
a calculation equation for an offset

$$Δ {V}_{dck}^{*}$$

of DC components of outputs of each phase of the bipolar output inverter,

$$\{ \begin{matrix}Δ {V}_{dck}^{*} = {k}_{p 6} ( {I}_{p d}^{*} - {I}_{pdk}^{*} ) + {k}_{i 6} \int ( {I}_{p d}^{*} - {I}_{pdk}^{*} ) d t \\ {I}_{pdk}^{*} = {k}_{p 7} ( \sum {V}_{S M}^{*} / 3 - \sum {V}_{SMk} ) + {k}_{i 7} \int ( \sum {V}_{S M}^{*} / 3 - \sum {V}_{SMk} ) d t\end{matrix}$$

wherein

$${I}_{pdk}^{*}$$

is a reference value of a d-axis component of an AC component of a k-phase current in the bipolar output inverter, EV SA is an instantaneous value of the sum of capacitor voltages of phase k of the bipolar output inverter, kₚ₆,kₚ₇ is a gain coefficient of a proportional part of a proportional-integral controller, and kᵢ₆,kᵢ₇ is a gain coefficient of an integral part of the proportional-integral controller.

As the control method for balancing phase-to-phase voltages of the bipolar output inverter in the series-parallel multi-port flexible interconnection device provided by the invention, the control method comprises: adjusting the DC components of the outputs of each phase of the bipolar output inverter based on a deviation of the sum of capacitor voltages in submodules of each phase of the bipolar output inverter, and controlling an active power exchange of each phase of the bipolar output inverter without affecting a voltage balance of a bus capacitor in the power flow regulation module, thereby achieving consistency in the phase-to-phase voltages of the bipolar output inverter.

The invention also provides the following technical scheme. A distribution method for the AC output port voltage of the unipolar output inverters in the series-parallel multi-port flexible interconnection device is provided, and the voltage distribution method satisfies the following basic condition equations:

$$\{ \begin{matrix}{\vec{V}}_{C 1} - {\vec{V}}_{Ck} = Δ \vec{{V}_{1 k}} ( k = 2 , 3 , … , n ) \\ Re al ( {\sum }_{k 1}^{n} {\vec{V}}_{C k} \cdot {\vec{I}}_{k}^{*} - {V}_{link} {I}_{cir} ) = 0\end{matrix}$$

where a first feeder is designated as the constant reactive power control feeder, \vec{V}_{Ck} is a vector expression for an AC component of the AC output port voltage of the unipolar output inverter on a k^{th} feeder of the series-parallel multi-port flexible interconnection device, Δ\vec{V}₁ₖ is an expression for a power flow regulation equivalent voltage to be inserted in series between the first feeder and the k^{th} feeder in order to attain a desired power flow on the k^{th} feeder,

$${\vec{I}}_{k}^{{}_{{}_{*}}}$$

is a conjugate vector expression of an AC on the k^{th} feeder, and n is the number of feeders interconnected through the series-parallel multi-port flexible interconnection device; and
the series-parallel multi-port flexible interconnection device with active power flow control capability for AC grids distributes the AC output port voltage of the unipolar output inverter on a distribution feeder according to any set of solutions to {\vec{V}_{Ck}(k=1, 2, . . . , n)} that satisfy the basic condition equations.

As the distribution method for the AC output port voltage of the unipolar output inverters in the series-parallel multi-port flexible interconnection device provided by the invention, the distribution method comprises: satisfying \vec{V}_{C1}=Δ\vec{V}₁ₖ 2(k=2, 3, . . . , n).

As the distribution method for the AC output port voltage of the unipolar output inverters in the series-parallel multi-port flexible interconnection device provided by the invention, the distribution method comprises: minimizing

$$Re al ( {\sum }_{k 1}^{n} {\vec{V}}_{C k} \cdot {\vec{I}}_{k}^{*} ) ,$$

meaning the selection of \vec{V}_{C1} fulfills the criterion of minimal

$$Re al ( {\sum }_{k 1}^{n} {\vec{V}}_{C k} \cdot {\vec{I}}_{k}^{*} ) .$$

As the distribution method for the AC output port voltage of the unipolar output inverters in the series-parallel multi-port flexible interconnection device provided by the invention, the distribution method comprises: selecting \vec{V}_{C1} such that max {|\vec{V}_{Ck} (k=1, 2, . . . , n)} achieves a minimum value.

As the distribution method for the AC output port voltage of the unipolar output inverters in the series-parallel multi-port flexible interconnection device provided by the invention, the distribution method further comprises any selection approach which satisfies the basic condition equations.

The invention also provides the following technical scheme. A starting method of the series-parallel multi-port flexible interconnection device may comprise three stages, wherein
the first stage is an uncontrolled rectification stage, where grid connection is established after a current-limiting resistor is placed in series with the AC output port, all switches are locked, and an uncontrolled rectification circuit formed by diodes charges capacitors within the series-parallel multi-port flexible interconnection device;
the second stage is a controlled rectification stage, where after the charging in the first stage is completed, the capacitors are alternately connected to or disconnected from a charging circuit in such a way that the total number of capacitors in the charging circuit remains constant, charging a voltage of the capacitors within the series-parallel multi-port flexible interconnection device to near a rated value; and
the third stage is a ramp-up voltage boosting stage, where after the charging in the second stage is completed, the current-limiting resistor is removed, and by applying a ramp-up reference voltage, a voltage control loop is utilized to charge the capacitor voltage to the rated value, the voltage control loop comprising the common connection bus voltage balance control loop described in the second aspect of the invention and the voltage control outer loop of the bipolar output inverter control loop.

The invention also provides the following technical scheme. A protection method of the series-parallel multi-port flexible interconnection device in the event of feeder faults comprises:
after AC feeder area protection completes the identification of faulty feeders and fault points, sending a tripping signal to the flexible interconnection device;
locking all switches, and after dead time protection, triggering a thyristor bypass switch of the power flow regulation module to cut off a power interchanging channel between the feeder and the common connection bus, thereby protecting the power flow regulation module; and
making a circuit breaker at an outlet of a corresponding port of the device trip to disconnect from the faulty feeders, and depending on whether voltages of common connection bus capacitors and DC-side capacitors of the bipolar output inverter exceed a set value, deciding whether to connect or disconnect a DC load shedding circuit to maintain DC voltages of all parts within a safe range.

As the protection method of the series-parallel multi-port flexible interconnection device in the event of feeder faults provided by the invention, the method further comprises:
equipping a lower bridge arm of each unipolar output inverter with a thyristor bypass switch connected in parallel thereto, which consists of two thyristors connected in reverse parallel and an inductor in series, allowing for rapid bypassing of the unipolar output inverter, and clamping a voltage in series on the feeder to approximately 0 V_{id}.

As the protection method of the series-parallel multi-port flexible interconnection device in the event of feeder faults provided by the invention, the method further comprises:
connecting the common connection bus capacitors and the DC-side capacitors of the bipolar output inverter in parallel to the DC load shedding circuit for the release of bus energy.

The invention also provides the following technical scheme. A control system of the series-parallel multi-port flexible interconnection device adopts a centralized control framework, that is, a line power flow control loop, a bipolar output inverter control loop, and a common connection bus voltage balance control loop are all integrated within a single controller.

As the control system of the series-parallel multi-port flexible interconnection device provided by the invention, the control system may also adopt a distributed control framework, achieving control through multiple controllers of the same level, with no communication between controllers of the same level.

As the control system of the series-parallel multi-port flexible interconnection device provided by the invention, the control system may also adopt a hierarchical control framework which combines centralized and distributed control, achieving control through multiple controllers of different levels, with information communication between different levels of controllers and no communication between controllers of the same level.

As the control system of the series-parallel multi-port flexible interconnection device provided by the invention, the controllers are hardware equipment capable of performing control loop functions.

Compared with existing flexible interconnection devices, the invention has the following beneficial effects.
1. Current static synchronous compensators only have reactive power compensation capability and lack functionalities for multi-AC feeder interconnection and active power flow decoupling control. In contrast, this invention introduces a multi-port power flow regulation module, providing multiple AC interconnection ports to achieve multi-AC feeder interconnection. It also allows for active decoupling control of active and reactive power in each feeder by adjusting the amplitude and phase of the power flow regulation equivalent voltage that is connected in series with the feeder.
2. The present invention, compared to existing commonly used flexible interconnection devices, such as back-to-back voltage source inverters, does not require a full-power structure and utilizes a series voltage source approach to achieve active power flow control. As a result, the inverter device offers advantages such as lower cost, smaller size, reduced footprint, lower losses, and faster responses.
3. The series-parallel multi-port flexible interconnection device in the invention features a modular design, allowing for rapid and economical expansion of interconnection ports by increasing the number of parallel unipolar output inverters in the power flow regulation module.
4. Compared to a multi-port flexible interconnection device using star-connected bipolar output inverters, the invention alleviates the energy balance issues in the power flow regulation module caused by the modulation constraints of unipolar output inverters. By injecting circulating currents within the bipolar output inverter, the energy exchange between the power flow regulation module and the bipolar output inverter is realized, thereby expanding the power flow regulation range of the interconnection device.
5. In the bipolar output inverter of the invention, DC circulating currents may exist, allowing for the adjustment of the DC components of the outputs of each phase of the bipolar output inverter. An active power exchange of each phase of the bipolar output inverter is controlled without affecting a voltage balance of a bus capacitor in the power flow regulation module, thereby achieving consistency in the phase-to-phase voltages of the bipolar output inverter.

### BRIEF DESCRIPTION OF THE DRAWINGS

In order to explain the technical solution in the embodiments of the present invention more clearly, the drawings used in the embodiments will be briefly introduced below. Obviously, the drawings in the following description are only some embodiments of the present invention, and for those of ordinary skill in the art, other drawings can be obtained according to these drawings without paying creative labor.

FIG. 1 is a schematic diagram of a topology of a series-parallel multi-port flexible interconnection device provided in the present invention, featuring two second unipolar output inverters per phase, along with its interconnected multi-feeder system;

FIG. 2 is a schematic diagram of a topology of a series-parallel multi-port flexible interconnection device provided in the present invention, featuring one second unipolar output inverter per phase, along with its interconnected multi-feeder system;

FIG. 3 is a schematic diagram of a topology of a series-parallel multi-port flexible interconnection device provided in the present invention, featuring one second unipolar output inverter per phase, along with its interconnected multi-feeder system;

FIG. 4 is a schematic diagram of a topology of a series-parallel multi-port flexible interconnection device provided in the present invention, which omits second unipolar output inverters connected to a bipolar output inverter, along with its interconnected multi-feeder system;

FIGS. 5A-5B show a typical topology example of a unipolar output inverter and a bipolar output inverter in a series-parallel multi-port flexible interconnection device provided in the present invention;

FIG. 6 is a block diagram of a control method of a line power flow control loop in a series-parallel multi-port flexible interconnection device provided in the present invention;

FIG. 7 is a block diagram of a control method of a bipolar output inverter control loop in a serial-parallel multi-port flexible interconnection device provided in the present invention;

FIG. 8 is a block diagram of a control method of a common connection bus voltage balance control loop in a series-parallel multi-port flexible interconnection device provided in the present invention;

FIGS. 9 and 10 illustrate the stages of a starting method of a series-parallel multi-port flexible interconnection device provided in the present invention;

FIGS. 11 and 12 illustrate a protection method of a series-parallel multi-port flexible interconnection device provided in the present invention in the event of feeder faults, as well as a protection device;

FIG. 13 is a schematic diagram of a topology of a series-parallel two-port flexible interconnection device in Embodiment 1, where a power flow regulation module employs parallel two-level half-bridge inverters, and a bipolar output inverter uses a cascaded full-bridge topology, along with a system achieving interconnection of two feeders;

FIG. 14 is a schematic diagram of a topology of a series-parallel three-port flexible interconnection device in Embodiment 2, where a power flow regulation module employs parallel two-level half-bridge inverters, and a bipolar output inverter uses a cascaded full-bridge topology, along with a system achieving interconnection of three feeders;

FIG. 15 presents simulation waveform graphs of power flow in each feeder, voltages across each capacitor within a device, and currents of each feeder under first operating conditions in Embodiment 1;

FIG. 16 presents simulation waveform graphs of power flow in each feeder, voltages across each capacitor within a device, and currents of each feeder under second operating conditions in Embodiment 1;

FIG. 17 presents simulation waveform graphs of power flow in each feeder, voltages across each capacitor within a device, and currents of each feeder under third operating conditions in Embodiment 1; and

FIGS. 18 and 19 present simulation waveform graphs of power flow in each feeder, voltages across each capacitor within a device, and currents of each feeder in Embodiment 2.

### DETAILED DESCRIPTION OF THE EMBODIMENTS

In order to make the purposes, features and advantages of the invention clearer, the embodiments of the invention will be described in more detail below in combination with attached drawings. Obviously, the described embodiments are only part of the embodiments of the invention, not all of them. Based on the embodiments of the invention, all other embodiments obtained by those of ordinary skill in the art without making creative labor shall belong to the scope of protection of the invention.

In the following description, specific details are set forth in order to fully understand the invention. However, the invention can be implemented in many other ways different from those described here, and those skilled in the art can make similar extension without violating the connotation of the invention. Therefore, the invention is not limited by the specific embodiments disclosed below.

Further, “one embodiment” or “embodiment” here refers to a specific feature, structure or characteristic which can be included in at least one implementation of the invention. The appearances of “in one embodiment” in different places of this specification do not all refer to the same embodiment, nor are they separate or selective embodiments mutually exclusive of other embodiments.

The present invention will be described in detail with reference to the schematic diagrams. When describing the embodiments of the present invention in detail, for the sake of clarity, the cross-sectional view representing the device structure is partially enlarged not to scale, and the said schematic diagram is merely illustrative and should not limit the scope of protection of the present invention herein. In addition, the three-dimensional dimensions of length, width and depth should be included in actual production.

In the description of the invention, it should be noted that directional or positional relationships indicated by the terms such as “upper”, “lower”, “inner” and “outer” are based on the directional or positional relationships shown in the drawings, which are only for the convenience of describing the invention and simplifying the description, but do not indicate or imply that the referred devices or elements must have a specific orientation or be constructed and operated in a specific orientation, so they cannot be understood as limiting the invention. In addition, the terms “first”, “second” and “third” are only used for descriptive purposes and cannot be understood as indicating or implying relative importance.

In the description of the invention, the terms “install” and “connect” should be understood in a broad sense unless otherwise specified and defined. For example, it may be fixed connection, detachable connection or integrated connection; it may be mechanical connection or electric connection; and it may be direct connection, indirect connection through intermediate media, or internal communication of two elements. For those of ordinary skill in the art, the specific meanings of the above terms in the invention may be understood according to specific situations.

### Embodiment 1

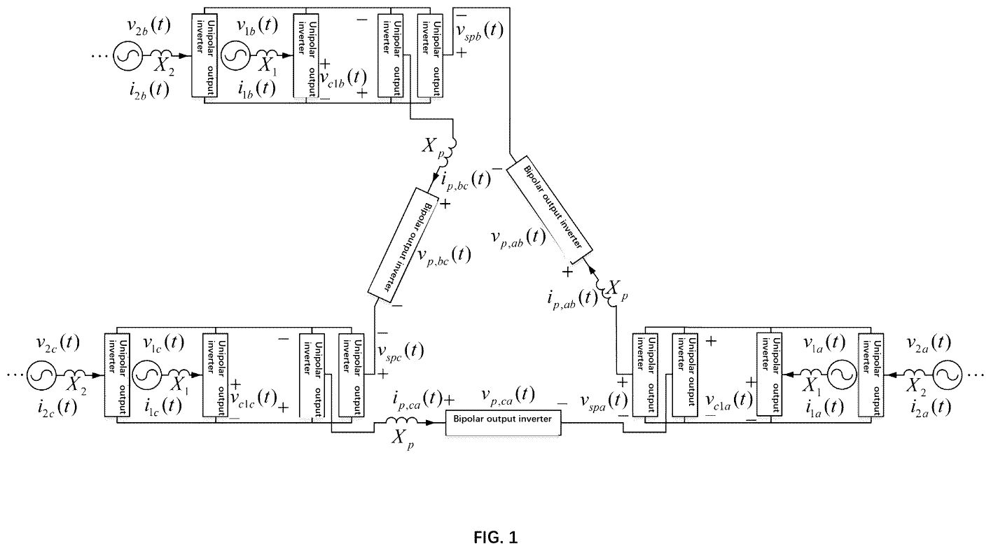

Refer to FIGS. 1-12 which illustrate a first embodiment of the invention. A series-parallel multi-port flexible interconnection device with active power flow control capability for distribution networks is provided in this embodiment, comprising:
a bipolar output inverter and a multi-port flexible interconnection module connected in series therewith, wherein the bipolar output inverter features bipolar output voltage and reactive power interchangeability, so as to absorb reactive power from a system or provide reactive power to the system;
the multi-port flexible interconnection module comprises multiple unipolar output inverters which share the same common connection bus and are connected in parallel, AC output ports of the unipolar output inverters are interconnected with feeders, and by adjusting the amplitude and phase of an AC output port voltage of the unipolar output inverters connected in series between the feeders, active control of active and reactive power of the feeders is achieved; and an AC component of the AC output port voltage of the unipolar output inverters connected in series between the feeders is defined as a power flow regulation equivalent voltage, and the multi-port flexible interconnection module is defined as a power flow regulation module.

Further, as shown in FIG. 1, the power flow regulation module may further comprise a second unipolar output inverter connected in parallel with the unipolar output inverters, and the second unipolar output inverter enables the connection between the bipolar output inverter and feeder-side unipolar output inverters.

It should be noted that when the power flow regulation module comprises both feeder-side unipolar output inverters and second unipolar output inverters, the AC output ports of the two second unipolar output inverters for each phase can be connected to respective ends of two phases of the bipolar output inverter, as depicted in the connection shown in FIG. 1. This arrangement also allows for the connection between the bipolar output inverter and the multi-port flexible interconnection module. In this case, by adjusting the frequency, amplitude, and phase of the voltage at the AC output ports of the second unipolar output inverters, circulating currents can be injected into the bipolar output inverter, stabilizing the voltage of the common connection bus in the power flow regulation module.

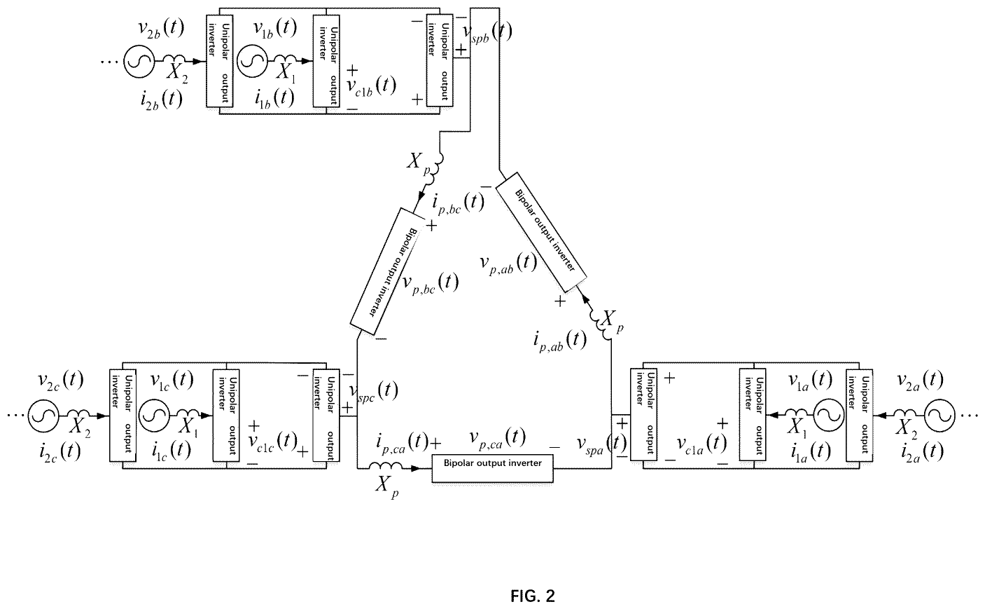

Further, as shown in FIG. 2, when the power flow regulation module comprises both feeder-side unipolar output inverters and second unipolar output inverters, the AC output port of the second unipolar output inverter for each phase can be simultaneously connected to respective ends of two phases of the bipolar output inverter, as depicted in the connection shown in FIG. 2. This arrangement also allows for the connection between the bipolar output inverter and the multi-port flexible interconnection module. In this case, by adjusting the amplitude and phase of the voltage at the AC output ports of the second unipolar output inverters, power balance flowing into the common connection bus is maintained, stabilizing the voltage of the common connection bus in the power flow regulation module.

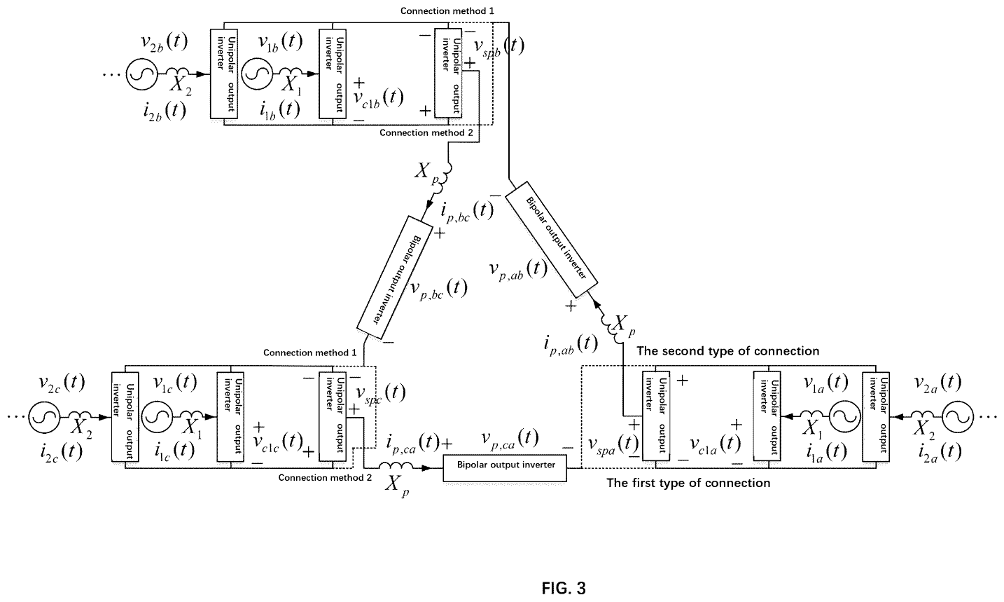

Further, as shown in FIG. 3, when the power flow regulation module comprises both feeder-side unipolar output inverters and second unipolar output inverters, one end of a certain phase of the bipolar output inverter can also be connected to the AC output port of the second unipolar output inverter for each phase, while one end of another phase of the bipolar output inverter is connected to one end of the common connection bus where the second unipolar output inverter is located, as depicted in the connection shown in FIG. 3 (dashed lines represent two types of connections). This arrangement also allows for the series connection between the bipolar output inverter and the multi-port flexible interconnection module. In this case, by adjusting the frequency, amplitude, and phase of the voltage at the AC output ports of the second unipolar output inverters, circulating current can be injected into the bipolar output inverter, stabilizing the voltage of the common connection bus in the power flow regulation module.

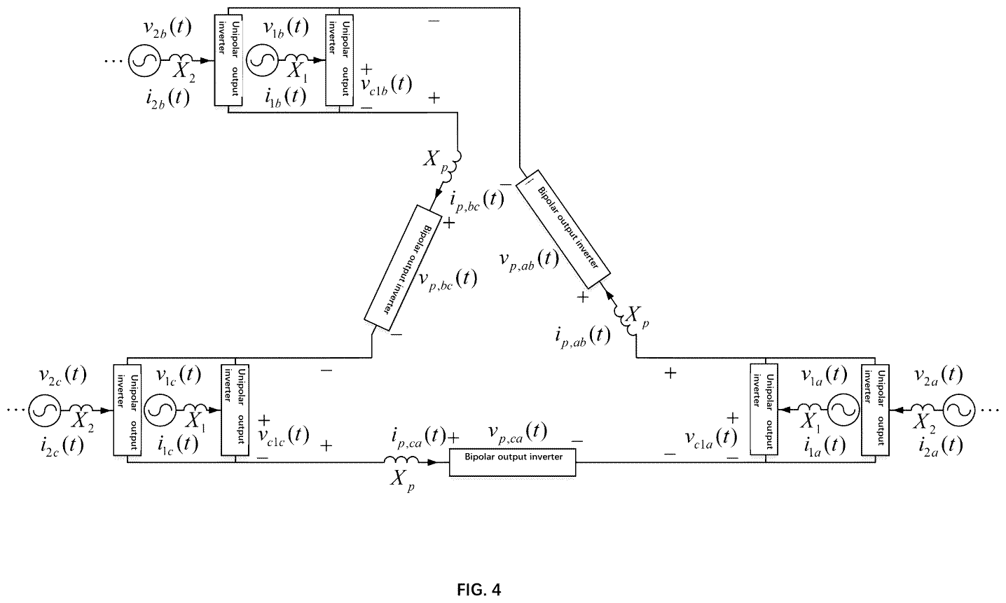

Further, as shown in FIG. 4, when the power flow regulation module only comprises feeder-side unipolar output inverters, respective ends of two phases of the bipolar output inverter can also be connected to two ends of the common connection bus, enabling series connection between the bipolar output inverter and the feeder-side unipolar output inverter, as depicted in the connection shown in FIG. 4. In this case, by adjusting the amplitude of the DC voltage at the AC output port of the bipolar output inverter, DC circulating currents can be injected into the bipolar output inverter, stabilizing the voltage of the common connection bus in the power flow regulation module.

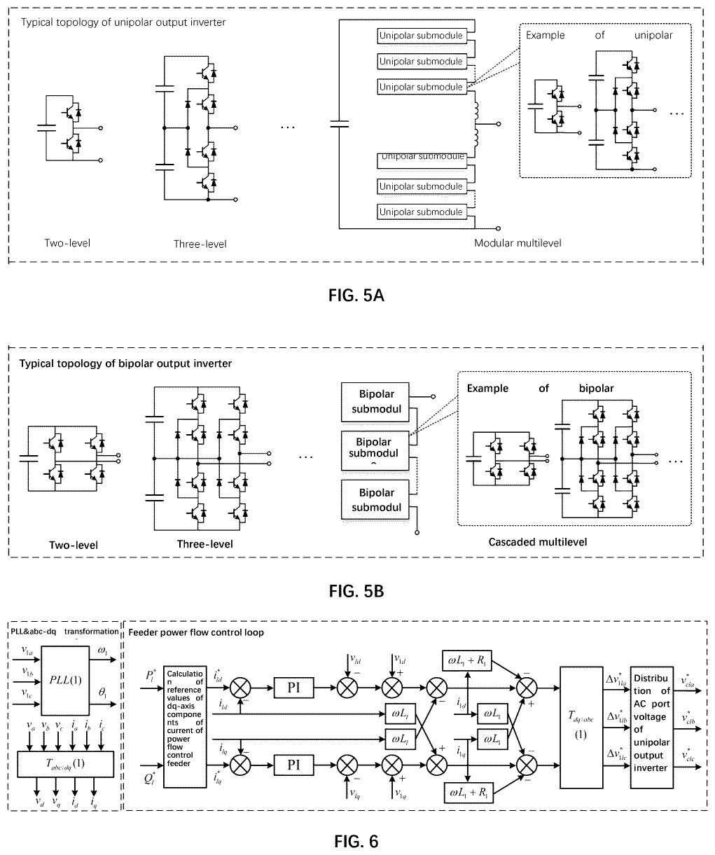

Further, as shown in FIG. 5B, a topology of the bipolar output inverter is a two-level full-bridge inverter, a three-level full-bridge inverter, or any other bipolar output inverter which allows for bidirectional power flow, or a cascaded bipolar output inverter with, for example, submodules employing two-level or three-level full-bridge topologies.

Further, as shown in FIG. 5A, a topology of the unipolar output inverter (or the second unipolar output inverter) in the power flow regulation module is a two-level half-bridge inverter, a three-level half-bridge inverter, or any other unipolar output inverter which allows for bidirectional power flow, or a modular multilevel single-phase current converter, among others.

The invention also provides a control method of the series-parallel multi-port flexible interconnection device, which comprises a line power flow control loop, a bipolar output inverter control loop, and a common connection bus voltage balance control loop, wherein in response to the series-parallel multi-port flexible interconnection device being interconnected with multiple feeders, the active power magnitude of one and only one feeder is determined by the active power balance requirements of a system, only the reactive power magnitude of the said feeder needs to be controlled, and the said feeder is referred to as a constant reactive power control feeder; for the other feeders, both active power and reactive power need to be controlled, referred to as power flow control feeders;
a phase-locked loop 1 locks onto a three-phase phase voltage at the nodes of the constant reactive power control feeder, and a phase angle output from the phase-locked loop provides an angle for the Park's transformation matrix from an abc coordinate system to a dq coordinate system, which is used by the line power flow control loop; and a phase-locked loop 2 locks onto a three-phase line voltage at the nodes of the constant reactive power control feeder, and a phase angle output from the phase-locked loop provides an angle for the Park's transformation matrix from an abc coordinate system to a dq coordinate system, which is used by the bipolar output inverter control loop.

Further, the control objective of the line power flow control loop is to ensure that the active power of the power flow control feeder reaches a reference value

$${P}_{j}^{*}$$

and the reactive power reaches a reference value

$${Q}_{j}^{*} ;$$

an output of the line power flow control loop is set to be

$$Δ {\vec{V}}_{ij}^{*} = {\vec{V}}_{Ci}^{*} - {\vec{V}}_{Cj}^{*} ;$$

where

$${\vec{V}}_{Ci}^{*}$$

is a reference value or an AC component of an output voltage at an AC output port of the unipolar output inverter connected to the constant reactive power control feeder,

$${\vec{V}}_{Cj}^{*}$$

is a reference value of an AC component of an output voltage at ad AC output the unipolar output inverter connected to the power flow control feeder, the subscript i indicates an i^{th} feeder as the constant reactive power control feeder, and the subscript j denotes a j^{th} power flow control feeder.

Further, the line power flow control loop first calculates a d-axis component reference value

$${I}_{jd}^{*}$$

and a q-axis component reference value

$${I}_{jq}^{*}$$

of the power flow control feeder current based on the active power reference value and reactive power reference value of the power flow control feeder. The calculation method involves solving the following equation set:

$$\{ \begin{matrix}{P}_{j}^{*} = f ( {I}_{jd}^{*} , {I}_{jq}^{*} ) = \frac{3}{2} ( {V}_{jd} {I}_{jd}^{*} + {V}_{jq} {I}_{jq}^{*} ) \\ {Q}_{j}^{*} = f ( {I}_{jd}^{*} , {I}_{jq}^{*} ) = \frac{3}{2} ( {V}_{jq} {I}_{jd}^{*} - {V}_{jd} {I}_{jq}^{*} )\end{matrix}$$

the line power flow control loop operates in a dq coordinate system, utilizing a proportional-integral controller for control, with the mathematical equation as follows:

$$\{ \begin{matrix}\begin{matrix}Δ {V}_{i j d}^{*} = {k}_{p} ( {I}_{j d}^{*} - {I}_{j d} ) + \int {k}_{i} ( {I}_{j d}^{*} - {I}_{j d} ) dt + \\ {V}_{i d} - {V}_{j d} - {I}_{i d} ( ω {L}_{i} + {R}_{i} ) - {I}_{j q} ω {L}_{j} + {I}_{i q} ω {L}_{i}\end{matrix} \\ \begin{matrix}Δ {V}_{i j q}^{*} = {k}_{p} ( {I}_{j q}^{*} - {I}_{j q} ) + \int {k}_{i} ( {I}_{j q}^{*} - {I}_{j q} ) dt + \\ {V}_{i q} - {V}_{j q} - {I}_{i q} ( ω {L}_{i} + {R}_{i} ) + {I}_{j d} ω {L}_{j} - {I}_{i d} ω {L}_{i}\end{matrix}\end{matrix}$$

where

$$Δ {V}_{i j d}^{*} and Δ {V}_{i j q}^{*}$$

are multiplied by a Park's inverse transformation matrix to obtain an output reference voltage

$$Δ {\vec{V}}_{ij}^{*}$$

of the line power flow control loop in an abc coordinate system, that is,

$$Δ {V}_{ija}^{*} , Δ {V}_{ijb}^{*} , Δ {V}_{ijc}^{*} .$$

Here, V represents a node voltage of the feeder, I represents a current of the feeder, ω represents an AC angular frequency of the feeder, L represents an equivalent inductance value of the feeder, and R represents an equivalent resistance value of the feeder. The subscripts i of V, I, L, R indicate parameters for the constant reactive power control feeder, the subscript j refers to parameters for a j^{th} power flow control feeder, the subscript d denotes the d-axis component, the subscript q denotes the q-axis component, and the superscript * represents reference values; kₚ is a gain coefficient of a proportional part of the proportional-integral controller, and kᵢ is a gain coefficient of an integral part of the proportional-integral controller; and V_{id}, V_{iq}, V_{jd}, V_{jq}, I_{id}(ωLᵢ+Rᵢ), I_{iq}(ωLᵢ+Rᵢ) is a feedforward term to enhance the disturbance resistance of the control loop and accelerate the response speed of the control loop, and I_{jq}ωLⱼ, I_{jd}ωLⱼ, I_{iq} ωLᵢ, I_{id}ωLᵢ is a decoupling term aimed at achieving decoupled control of the d-axis and q-axis, as shown in FIG. 6.

Further, the control objective of the bipolar output inverter control loop is to ensure that the reactive power of the constant reactive power control feeder reaches a reference value

$${Q}_{i}^{*}$$

and the sum of three-phase capacitor voltages of the bipolar output inverter is stabilized at a reference value

$$\sum {V}_{S M}^{*} ,$$

and an output thereof is a reference value

$${\vec{V}}_{p}^{*}$$

of an AC component of a voltage at an AC output port of the bipolar output inverter; and the bipolar output inverter control loop consists of a voltage control outer loop, a reactive power control outer loop, and a current control inner loop.

Further, the voltage control outer loop uses a proportional-integral controller to control the sum of three-phase capacitor voltages of the bipolar output inverter. An input is the difference between a reference value and an instantaneous value of the sum of the three-phase capacitor voltages of the bipolar output inverter, and an output is a reference value

$${I}_{ipd}^{*}$$

of a d-axis component of an equivalent phase current of the constant reactive power control feeder. The mathematical equation is as follows:

$${I}_{ipd}^{*} = {k}_{p 1} ( \sum {V}_{S M}^{*} - \sum {V}_{S M} ) + \int {k}_{i 1} ( \sum {V}_{S M}^{*} - \sum {V}_{S M} ) d t - \sum {I}_{jpd}^{*}$$

where kₚ₁ is the gain coefficient of the proportional part of the proportional-integral controller, kᵢ₁ is the gain coefficient of the integral part of the proportional-integral controller, Σ^{V}_{SM} is the instantaneous value of the sum of the three-phase capacitor voltages of the bipolar output inverter, and

$$\sum {I}_{jpd}^{*}$$

is the sum of reference values of d-axis components of equivalent phase currents of the power flow control feeders.

Further, the reactive power control outer loop calculates a reference value

$${I}_{ipq}^{*}$$

of a q-axis component of an equivalent phase current of the constant reactive power control feeder based on the reactive power reference value

$${Q}_{i}^{*}$$

of the constant reactive power control feeder. The calculation formula is:

$${I}_{ipq}^{*} = - \frac{2 {Q}_{i}^{*}}{3 {V}_{ipd}}$$

where V_{ipd} is a line voltage at a node of the constant reactive power control feeder.

Further, the current control inner loop operates in a dq coordinate system, utilizing a proportional-integral controller to control the d-axis component and q-axis component of the equivalent phase current of the constant reactive power control feeder. The mathematical equation is as follows:

$$\{ \begin{matrix}{V}_{p d}^{*} = - [ {k}_{p 2} ( {I}_{p d}^{*} - {I}_{p d} ) + \int {k}_{i 2} ( {I}_{p d}^{*} - {I}_{p d} ) d t - {V}_{pcc , d} + {I}_{p q} ω {L}_{p} ] \\ {V}_{p q}^{*} = - [ {k}_{p 2} ( {I}_{p q}^{*} - {I}_{p q} ) + \int {k}_{i 2} ( {I}_{p q}^{*} - {I}_{p q} ) d t - {V}_{pcc , q} - {I}_{p d} ω {L}_{p} ]\end{matrix} \\ {V}_{p d}^{*} and {V}_{p q}^{*}$$

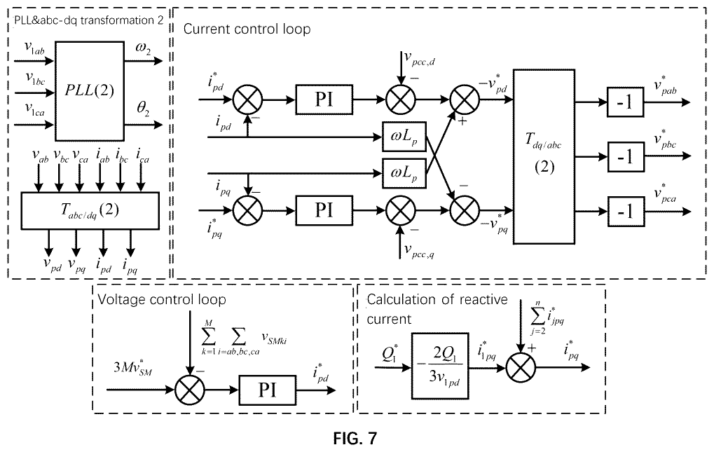

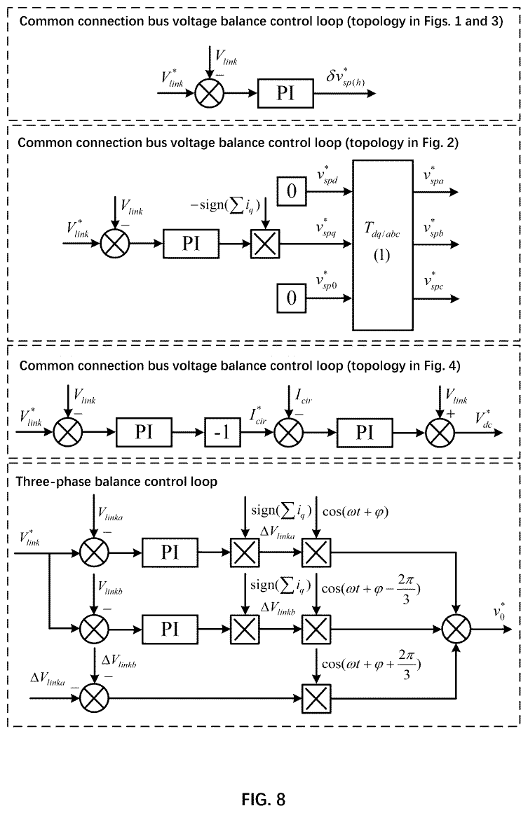

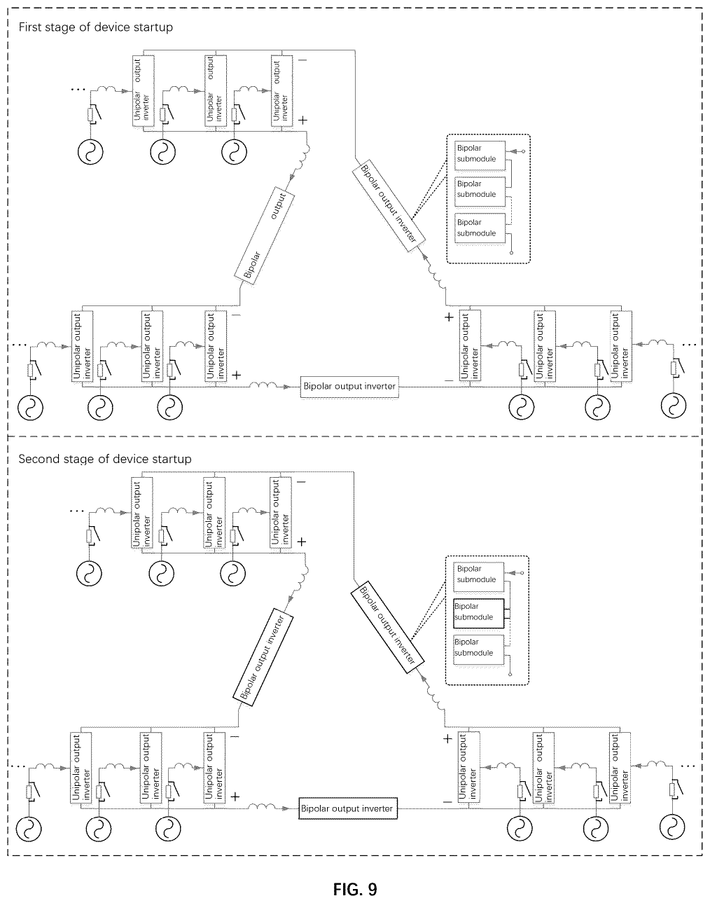

are multiplied by a Park's inverse transformation matrix to obtain an output reference voltage \vec{V} *ₚ of the bipolar output inverter control loop in an abc coordinate system, that is Vₚₐ, V_{pb}, V_{pc}; where I_{pd} and I_{pq} represent a d-axis component and q-axis component of an AC component of a three-phase phase current of the bipolar output inverter, and V_{pcc,d} and V_{pcc,q} represent a d-axis component and q-axis component of an AC component of an output and a total voltage (including inductance and resistance) for each phase of the bipolar output inverter; kₚ₂ is the gain coefficient of the proportional part of the proportional-integral controller, kᵢ₂ is the gain coefficient of the integral part of the proportional-integral controller, Lₚ is an inductance value for each phase connection in the bipolar output inverter, V_{pcc,d}, V_{pcc,q} is a feedforward term that enhances the disturbance resistance of the control loop and accelerates the response speed of the control loop, and I_{pd} ωLₚ, I_{pq} ωLₚ is a decoupling term that achieves decoupled control of the d-axis and q-axis, as shown in FIG. 7.

Further, the control objective of the common connection bus voltage balance control loop is to stabilize three-phase common connection bus voltages at a reference value V*ₗᵢₙₖ. The control of the common connection bus voltage balance control loop is conducted in an abc coordinate system and is divided into two parts: stabilization of an average value of the three-phase bus voltages and balancing of the three-phase bus voltages, as illustrated in FIG. 8.

Further, for the topologies shown in FIGS. 1 and 3, the average value of the three-phase bus voltages is stabilized. Both the second unipolar output inverter and the bipolar output inverter output three-phase in-phase harmonic voltages

$$Δ {V}_{sp ( h )}^{*} and {V}_{p ( h )}^{*} ,$$

with equal amplitudes and opposite phases, effectively canceling each other out. A proportional-integral controller is used to control the average value of the abc three-phase common connection bus voltages, and another harmonic voltage

$$δ {V}_{sp ( h )}^{*}$$

output by the bipolar output inverter that is orthogonal to

$$Δ {V}_{sp ( h )}^{*}$$

is calculated, in order to generate a harmonic current within the bipolar output inverter for energy transfer. The calculation formula is:

$$δ {V}_{s p ( h )}^{*} = {k}_{p b 1} ( {V}_{link}^{*} - {V}_{link} ) + {k}_{ib 1} \int ( {V}_{link}^{*} - {V}_{link} ) dt$$

where Vₗᵢₙₖ represents the average value of the three-phase common connection bus voltages, k_{pb1} is the gain coefficient of the proportional part of the proportional-integral controller, and k_{ib1} is the gain coefficient of the integral part of the proportional-integral controller.

Further, for the topology shown in FIG. 2, the average value of the three-phase bus voltages is stabilized. A proportional-integral controller is employed to control the average value of the

$$\{ \begin{matrix}{V}_{spd}^{*} = 0 \\ {{V}_{spq}^{*} = [ {k}_{pb 2} ( {V}_{link}^{*} - {V}_{link} ) + {k}_{ib 2} \int ( {V}_{link}^{*} - {V}_{link} ) d t ] [ - sign ( \sum {I}_{q} ) ]}_{}\end{matrix}$$

abc three-phase common connection bus voltages, and the amplitude and phase of a voltage at the AC output port of the second unipolar output inverter is calculated. The calculation formula is:
where

$${V}_{spd}^{*} , {V}_{spq}^{*}$$

denote d-axis and q-axis reference values of the voltage at the AC output port of the second unipolar output inverter, ΣI_{q} signifies a q-axis component of a total current of the feeders, sign represents a sign function, k_{pb2} is the gain coefficient of the proportional part of the proportional-integral controller, and k_{ib2} is the gain coefficient of the integral part of the proportional-integral controller.

Further, for the topology shown in FIG. 4, the average value of the three-phase bus voltages is stabilized. A proportional-integral controller is used to control the average value of the abc three-phase common connection bus voltages, a reference value

$${I}_{cir}^{*}$$

of an internal DC

$$\{ \begin{matrix}{I}_{cir}^{*} = - {k}_{p 3} ( {V}_{link}^{*} - {V}_{link} ) - {k}_{i 3} \int ( {V}_{link}^{*} - {V}_{link} ) dt \\ {V}_{d c}^{*} = {k}_{p 4} ( {I}_{cir}^{*} - {I}_{cir} ) + {k}_{i 4} \int ( {I}_{cir}^{*} - {I}_{cir} ) dt + {V}_{link}\end{matrix}$$

circulating current of the bipolar output inverter is calculated, and a reference value

$${V}_{d c}^{*}$$

of a DC component output by the bipolar output inverter is further calculated to generate a target circulating current. The calculation formula is:
where I_{cir} is the internal DC circulating current of the bipolar output inverter, kₚ₃, kₚ₄ is the gain coefficient of the proportional part of the proportional-integral controller, and kᵢ₃, kᵢ₄ is the gain coefficient of the integral part of the proportional-integral controller.

Further, the balanced three-phase bus voltages are achieved by superimposing a zero-sequence voltage on each unipolar output inverter in the power flow regulation module, controlling the active power exchange between three-phase bus capacitors and each feeder without affecting the power flow regulation, thereby achieving consistency in the three-phase bus voltages. A zero-sequence reference voltage

$${v}_{0}^{*}$$

at the AC output port of the unipolar output inverters is:

$$\{ \begin{matrix}\begin{matrix}{v}_{0}^{*} = Δ {V}_{linka} cos ( ω t + φ ) + Δ {V}_{linkb} cos ( ω t + φ - \frac{2 π}{3} ) + \\ ( - Δ {V}_{linka} - Δ {V}_{linkb} ) cos ( ω t + φ + \frac{2 π}{3} )\end{matrix} \\ Δ {V}_{linka} = [ {k}_{p 5} ( {V}_{link}^{*} - {V}_{linka} ) + {k}_{i 5} \int ( {V}_{link}^{*} - {V}_{linka} ) dt ] \cdot sign ( \sum {I}_{q} ) \\ Δ {V}_{linkb} = [ {k}_{p 5} ( {V}_{link}^{*} - {V}_{linkb} ) + {k}_{i5} \int ( {V}_{link}^{*} - {V}_{linkb} ) dt ] \cdot sign ( \sum {I}_{q} )\end{matrix}$$

where φ represents a phase angle difference between the total current of the feeders and a phase voltage at a node of the constant reactive power control feeder, kₚ₅ is the gain coefficient of the proportional part of the proportional-integral controller, and kᵢ₅ is the gain coefficient of the integral part of the proportional-integral controller.

The invention further provides a control method for balancing phase-to-phase voltages of the bipolar output inverter in the series-parallel multi-port flexible interconnection device. The control method comprises: adjusting the DC components of the outputs of each phase of the bipolar output inverter based on a deviation of the sum of capacitor voltages in submodules of each phase of the bipolar output inverter, and controlling an active power exchange of each phase of the bipolar output inverter without affecting a voltage balance of a bus capacitor in the power flow regulation module, thereby achieving consistency in the phase-to-phase voltages of the bipolar output inverter. A calculation equation for an offset

$$Δ {V}_{d c k}^{*}$$

of DC components of outputs of each phase of the bipolar output inverter is:

$$\{ \begin{matrix}Δ {V}_{d c k}^{*} = {k}_{p 6} ( {I}_{p d}^{*} - {I}_{p d k}^{*} ) + {k}_{i 6} \int ( {I}_{p d}^{*} - {I}_{pdk}^{*} ) d t \\ {I}_{pdk}^{*} = {k}_{p 7} ( \sum {V}_{S M}^{*} / 3 - \sum {V}_{SMk} ) + {k}_{i 7} \int ( \sum {V}_{SM}^{*} / 3 - \sum {V}_{SMk} ) d t\end{matrix}$$

where

$${I}_{pdk}^{*}$$

is a reference value of a d-axis component of an AC component of a k-phase current in the bipolar output inverter, Σ^{V}_{SMk} is an instantaneous value of the sum of capacitor voltages of phase k of the bipolar output inverter, kₚ₆, kₚ₇ is a gain coefficient of a proportional part of a proportional-integral controller, and kᵢ₆,kᵢ₇ is a gain coefficient of an integral part of the proportional-integral controller.

The invention further provides a distribution method for the AC output port voltage of the unipolar output inverters in the series-parallel multi-port flexible interconnection device under the condition that a power flow regulation equivalent voltage is given. The voltage distribution method satisfies the following basic condition equations:

$$\{ \begin{matrix}{\vec{V}}_{C 1} - {\vec{V}}_{C k} = Δ {\vec{V}}_{1 k} ( k = 2 , 3 , … , n ) \\ Re al ( {\sum }_{k = 1}^{n} {\vec{V}}_{C k} \cdot {\vec{I}}_{k}^{*} - {V}_{{link}_{}} {I}_{cir} ) = 0\end{matrix}$$

where a first feeder is designated as the constant reactive power control feeder, \vec{V}_{Ck} is a vector expression for an AC component of the AC output port voltage of the unipolar output inverter on a k^{th} feeder of the series-parallel multi-port flexible interconnection device, Δ\vec{V}ₗₖ is an expression for a power flow regulation equivalent voltage to be inserted in series between the first feeder and the k^{th} feeder, in order to attain a desired power flow on the k^{th} feeder,

$${\vec{I}}_{k}^{*}$$

is a conjugate vector expression of an AC on the k^{th} feeder, and n is the number of feeders interconnected through the series-parallel multi-port flexible interconnection device.

Further, the series-parallel multi-port flexible interconnection device with active power flow control capability for AC grids distributes the AC output port voltage of the unipolar output inverter on a distribution feeder according to any set of solutions to {\vec{V}_{Ck} (k=1, 2, . . . , n)} that satisfy the basic condition equations.

Further, the series-parallel multi-port flexible interconnection device with active power flow control capability for AC grids may distribute the AC output port voltage of the unipolar output inverter on a distribution feeder according to \vec{V}_{C1}=Δ\vec{V}ₗₖ/2(k=2, 3, . . . , n) characterized by its brevity.

Further, the AC output port voltage of the unipolar output inverter may also be distributed by minimizing

$$Re al ( {\sum }_{k = 1}^{n} {\vec{V}}_{C k} \cdot {\vec{I}}_{k}^{*} ) ,$$

meaning the selection of \vec{V}_{C1} fulfills the criterion of minimal

$$Re al ( {\sum }_{k = 1}^{n} {\vec{V}}_{C k} \cdot {\vec{I}}_{k}^{*} ) ,$$

so as to minimize the internal DC circulating current of the bipolar output inverter.

Further, the AC output port voltage of the unipolar output inverter may also be distributed by selecting \vec{V}_{C1} such that max {|\vec{V}_{Ck}|(k=1, 2, . . . , n)} is minimized, thereby ensuring that the amplitude of an AC component of an output voltage required by the unipolar output inverter is minimized, which corresponds to the minimum modulation index.

Further, the distribution method for the AC output port voltage of the unipolar output inverters may be any selection approach which satisfies the basic condition equations.

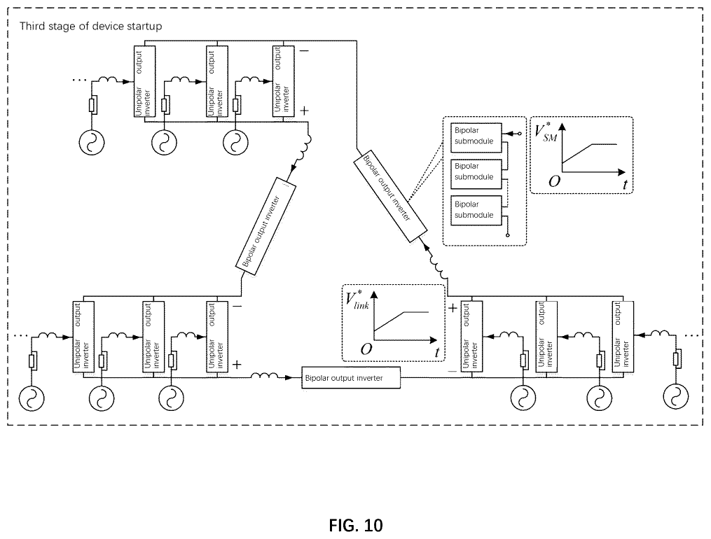

The invention also provides a starting method of the series-parallel multi-port flexible interconnection device, as shown in FIGS. 9 and 10, which may comprise three stages, wherein
the first stage is an uncontrolled rectification stage, where grid connection is established after a current-limiting resistor is placed in series with the AC output port, all switches are locked, and an uncontrolled rectification circuit formed by diodes charges capacitors within the series-parallel multi-port flexible interconnection device;
the second stage is a controlled rectification stage, where after the charging in the first stage is completed, the capacitors are alternately connected to or disconnected from a charging circuit in such a way that the total number of capacitors in the charging circuit remains constant, charging a voltage of the capacitors within the series-parallel multi-port flexible interconnection device to near a rated value; and
the third stage is a ramp-up voltage boosting stage, where after the charging in the second stage is completed, the current-limiting resistor is removed, and by applying a ramp-up reference voltage, a voltage control loop is utilized to charge the capacitor voltage to the rated value, the voltage control loop comprising the common connection bus voltage balance control loop described in the second aspect of the invention and the voltage control outer loop of the bipolar output inverter control loop.

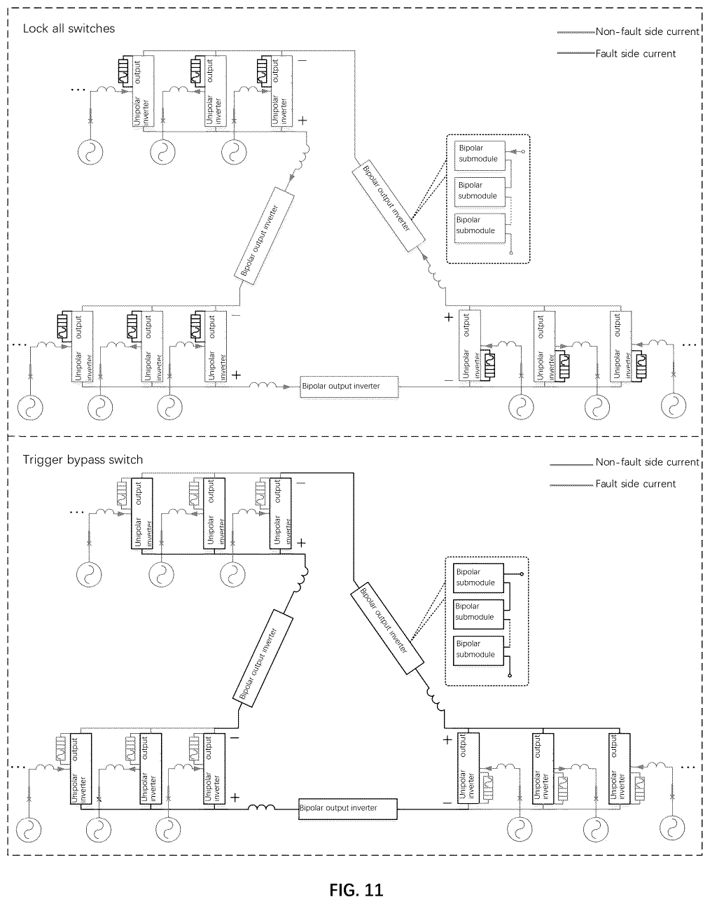

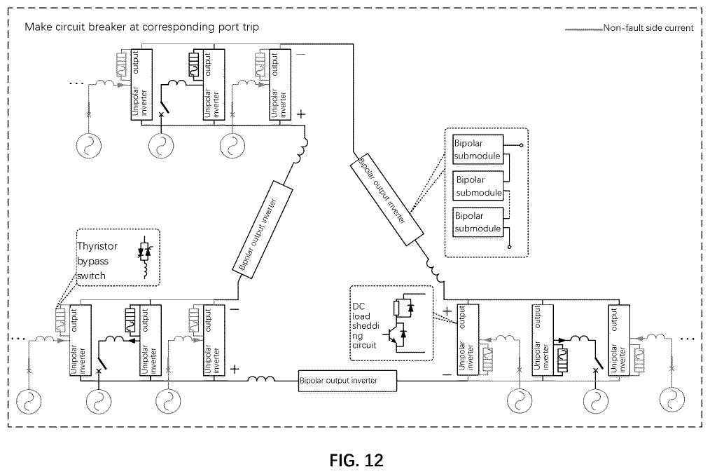

The invention also provides a protection method of the series-parallel multi-port flexible interconnection device in the event of feeder faults, as shown in FIGS. 11 and 12, which comprises: after AC feeder area protection completes the identification of faulty feeders and fault points, sending a tripping signal to the flexible interconnection device; locking all switches, and after dead time protection, triggering a thyristor bypass switch of the power flow regulation module to cut off a power interchanging channel between the feeder and the common connection bus, thereby protecting the power flow regulation module; and making a circuit breaker at an outlet of a corresponding port of the device trip to disconnect from the faulty feeders, and depending on whether voltages of common connection bus capacitors and DC-side capacitors of the bipolar output inverter exceed a set value, deciding whether to connect or disconnect a DC load shedding circuit to maintain DC voltages of all parts within a safe range.

It should be noted that a lower bridge arm of each unipolar output inverter is equipped with a thyristor bypass switch connected in parallel thereto, which consists of two thyristors connected in reverse parallel and an inductor in series, allowing for rapid bypassing of the unipolar output inverter, and a voltage in series on the feeder is clamped to approximately 0 V.

It should be noted that the common connection bus capacitors and the DC-side capacitors of the bipolar output inverter are connected in parallel to the DC load shedding circuit for the release of bus energy.

The invention also provides a control system of the series-parallel multi-port flexible interconnection device.

It should be noted that the control system of the series-parallel multi-port flexible interconnection device may adopt a centralized control framework, that is, a line power flow control loop, a bipolar output inverter control loop, and a common connection bus voltage balance control loop are all integrated within a single controller. The control system of the series-parallel multi-port flexible interconnection device may also adopt a distributed control framework, achieving control through multiple controllers of the same level, with no communication between controllers of the same level; for example, a line power flow control loop, a bipolar output inverter control loop, and a common connection bus voltage balance control loop are implemented in three different controllers.

It should be noted that the control system of the series-parallel multi-port flexible interconnection device may also adopt a hierarchical control framework which combines centralized and distributed control, achieving control through multiple controllers of different levels, with information communication between different levels of controllers and no communication between controllers of the same level; for example, the line power flow control loop and the equivalent voltage distribution calculations for power flow regulation are controlled within a primary controller, while the bipolar output inverter control loop and the common connection bus voltage balance control loop are controlled in two secondary controllers, with communication and interaction of control information occurring between the primary and secondary controllers. The controllers are hardware equipment capable of performing control loop functions, such as controllers based on digital signal processing chips or field-programmable gate array chips.

### Embodiment 2

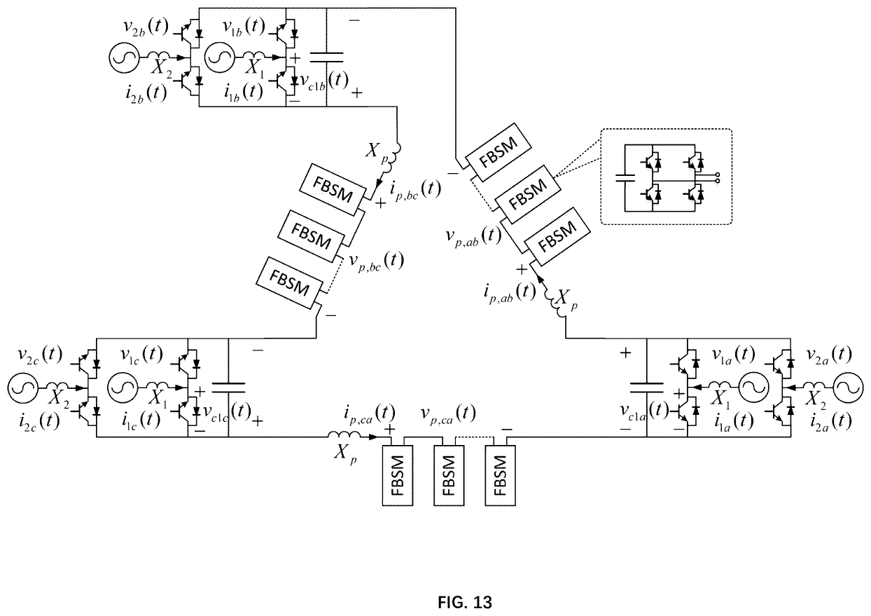

Referring to FIG. 13, the invention employs a series-parallel multi-port flexible interconnection device to realize the device topology and system connection for double feeder interconnection. The series-parallel multi-port flexible interconnection device consists of a bipolar output inverter with a three-phase cascaded full-bridge topology and a power flow regulation module connected thereto in series. The power flow regulation module comprises two two-level half-bridge inverters that share the same common connection bus, with each half-bridge inverter connected to one of two AC feeders. By adjusting the power flow regulation equivalent voltage in series on the feeder and the amplitude and phase of the AC component of the voltage at an AC output port of the bipolar output inverter, internal energy balance of the series-parallel multi-port flexible interconnection device is achieved, while also enabling active control of both active and reactive power on the AC feeders, thereby achieving decoupled control of line power flow.

For the double feeder interconnection system implemented by the series-parallel multi-port flexible interconnection device shown in FIG. 13, internal energy balance is manifested by the stability of the capacitor voltage on the common connection bus and the stability of the capacitor voltage within the bipolar output inverter. This requires that the active power flowing into the aforementioned capacitors remains zero, i.e.:

$$\{ \begin{matrix}Re al ( {\sum }_{k = 1}^{n} {\vec{V}}_{C k} \cdot {\vec{I}}_{k}^{*} - {V}_{{link}_{}} {I}_{cir} ) = 0 \\ Re al ( {\vec{V}}_{p} \cdot {\vec{I}}_{p}^{*} - {V}_{dc} {I}_{cir} ) = 0\end{matrix}$$

where the equation in the first row indicates that the active power flowing into the capacitor of the common connection bus is zero, and the equation in the second row indicates that the active power flowing into the capacitor of the bipolar output inverter is zero; \vec{V}_{C1} is the vector expression of the AC component of the voltage at the AC output port of the half-bridge inverter connected to feeder 1, \vec{V}_{C2} is the vector expression of the AC component of the voltage at the AC output port of the half-bridge inverter connected to feeder 2, \vec{V}ₚ is the vector expression of the AC component of the voltage at the AC output port of the bipolar output inverter, Vₗᵢₙₖ is the average value of three-phase common connection bus voltages, V_{dc} is the expression of the DC component of the voltage at the AC output port of the bipolar output inverter,

$${\vec{I}}_{1}^{*}$$

is the conjugate vector expression of the current in feeder 1,

$${\vec{I}}_{2}^{*}$$

is the conjugate vector expression of the current in feeder 2,

$${\vec{I}}_{p}^{*}$$

is the conjugate vector expression of the branch current of the bipolar output inverter, and I_{cir} is the internal DC circulating current of the bipolar output inverter. By adjusting the magnitudes of V_{dc} and \vec{V}ₚ, the above equations can be satisfied, thereby achieving internal energy balance in the series-parallel multi-port flexible interconnection device.

### Embodiment 3

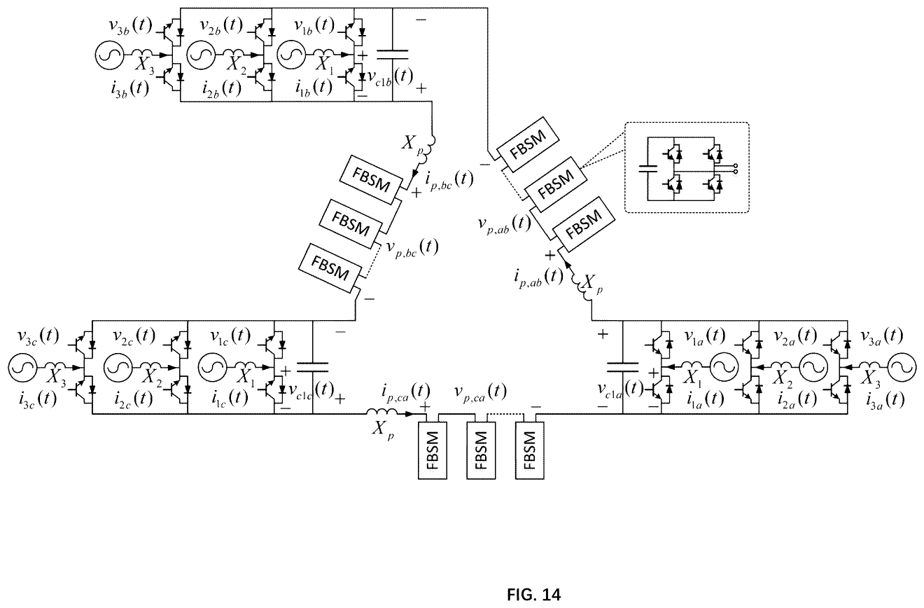

Referring to FIG. 14, a series-parallel multi-port flexible interconnection device is employed to realize three feeder interconnection. In this embodiment, the series-parallel multi-port flexible interconnection device consists of a bipolar output inverter with a three-phase cascaded full-bridge topology and a power flow regulation module connected thereto in series. The power flow regulation module comprises three two-level half-bridge inverters that share the same common connection bus, with each half-bridge inverter connected to one of three AC feeders. By adjusting the power flow regulation equivalent voltage in series on the feeder and the amplitude and phase of the AC component of the voltage at the AC output port of the bipolar output inverter, internal energy balance of the series-parallel multi-port flexible interconnection device is achieved, while also enabling active control of both active and reactive power on the AC feeders, thereby achieving decoupled control of line power flow.

In this embodiment, the principle for achieving internal energy balance in the series-parallel multi-port flexible interconnection device is the same as that described in the previous embodiment, and thus will not be repeated here.

The following provides further explanation of the application of the structures and methods in the two aforementioned embodiments, combined with specific simulation examples.

Based on the previous embodiments, MATLAB/Simulink 2018b software is used for system simulation and validation, with simulation parameters as shown in Table 1.

TABLE 1

| Parameter | Numerical value |
|---|---|
| Rated apparent power of feeder | S_{N} = 1 MV · A |
| Voltage of node 1 | V_{1, RMS} = 10 kV, θ₁ = 0° |
| Impedance of feeder 1 | L₁ = 31.8 mH, R₁ = 0.5Ω |
| Voltage of node 2 | V_{2, RMS} = 10 kV, θ₂ = −2° |
| Impedance of feeder 2 | L₂ = 31.8 mH, R₂ = 0.5Ω |
| Voltage of node 3 | V_{3, RMS} = 10 kV, θ₃ = −4° |
| Impedance of feeder 3 | L₃ = 31.8 mH, R₃ = 0.5Ω |
| Common connection capacitance | Cₗᵢₙₖ = 2.7 mF, Vₗᵢₙₖ = 2500 V |
| Connection impedance of bipolar | Lₚ = 63.6 mH, Rₚ = 1Ω |
| output inverter | |
| Capacitance of submodule of | C = 3 mF, V_{C} = 1400 V |
| bipolar output inverter | |
| Number of submodules of bipolar | 12 |
| output inverter | |
| Switching frequency | 3 kHz |

### Simulation Example 1

A double feeder interconnection system, which achieves flexible interconnectivity through a series-parallel multi-port flexible interconnection device, is illustrated in FIG. 13. Each phase of the device comprises two half-bridge inverters that control the active and reactive power on feeder 2, and the corresponding control loop is a line power flow control loop. A bipolar output inverter is directly connected to a common connection bus, the voltage balance of the common connection bus is achieved by injecting a DC circulating current through an output DC component, and the corresponding control loop is a common connection bus voltage balance control loop. The bipolar output inverter compensates for the reactive power on feeder 1, and the corresponding control loop is a bipolar output inverter control loop.

In a distribution method for the power flow regulation equivalent voltage on a distribution feeder of the series-parallel multi-port flexible interconnection device in Embodiment 1,

$${\vec{V}}_{C 1} = \frac{1}{2} Δ {\vec{V}}_{12}$$

is satisfied for the sake of simplicity.

To verify the active power flow control capability of the series-parallel multi-port flexible interconnection device, three operating conditions are set for the simulation.

Condition 1: Node 1 generates 0.6 p.u. reactive power, and Node 2 generates 0.8 p.u. active power and 0.6 p.u. reactive power. This simulates the conditions of heavy active power load and heavy reactive power load.

Condition 2: Node 1 generates 0.6 p.u. reactive power, and Node 2 absorbs 0.8 p.u. active power and generates 0.6 p.u. reactive power. This simulates the conditions of heavy active power load in the reverse direction and heavy reactive power load.

Condition 3: Node 1 generates 0.6 p.u. reactive power, and Node 2 generates 0.3 p.u. active power and 0.6 p.u. reactive power. This simulates the conditions of light active power load and heavy reactive power load.

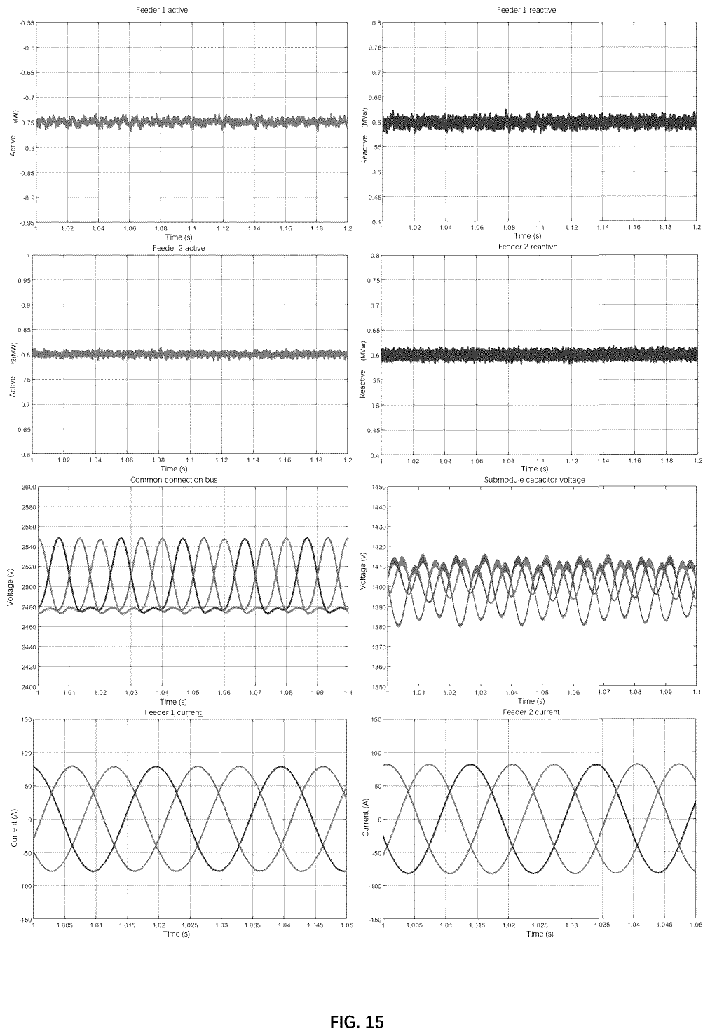

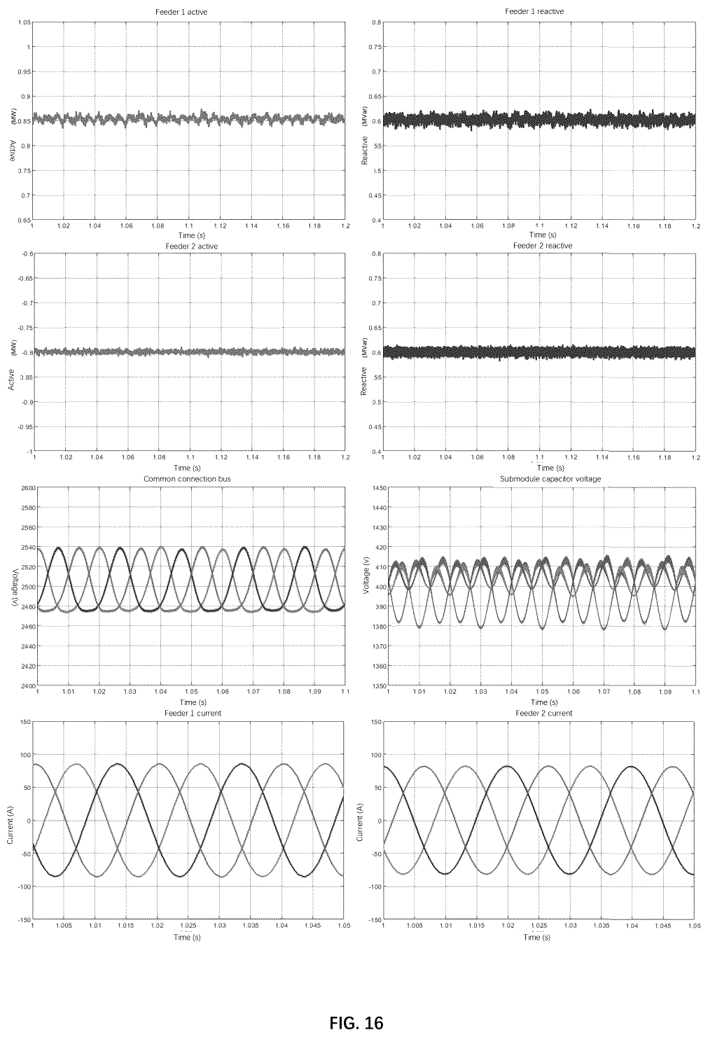

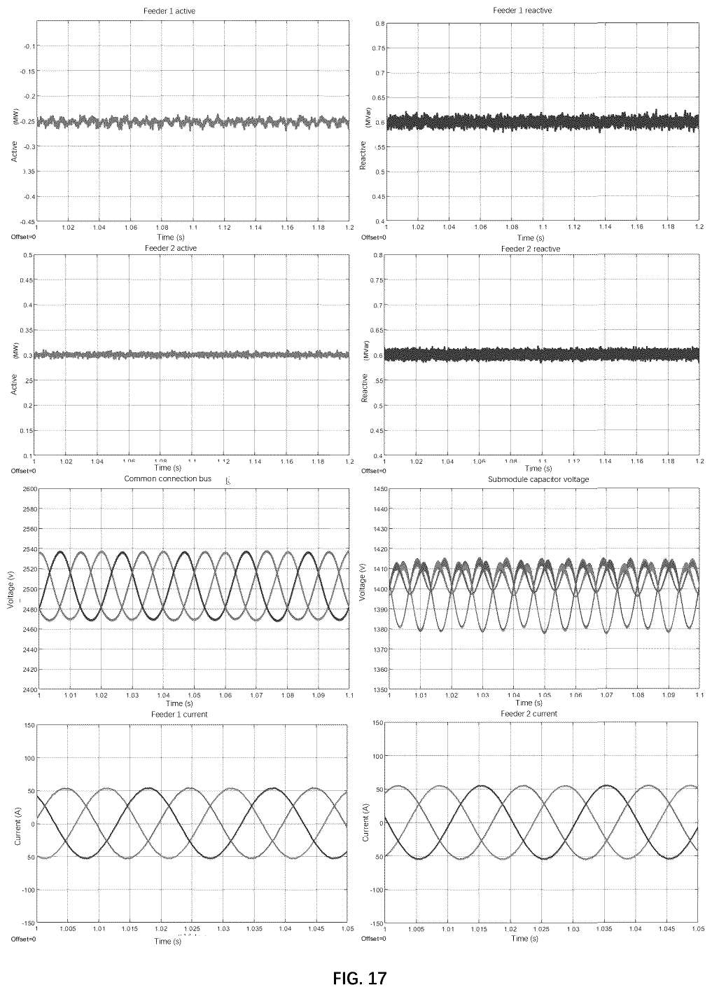

FIGS. 15, 16 and 17 show the simulation results for operating conditions 1-3 in Embodiment 1. Each figure contains eight waveform graphs. Shown from left to right and top to bottom are: feeder 1 active power P₁ waveform graph, feeder 1 reactive power Q₁ waveform graph, feeder 2 active power P₂ waveform graph, feeder 2 reactive power Q₂ waveform graph, three-phase common connection bus voltage Vlink_abc waveform graph, three-phase bipolar output inverter submodule capacitor voltage VCHB_capacitor_abc waveform graph, feeder 1 three-phase current I1abc waveform graph, and feeder 2 three-phase current I2abc waveform graph.

The simulation waveform results indicate that the series-parallel multi-port AC interconnection device can achieve active power flow control with decoupling of active power and reactive power on the interconnected feeders, while maintaining internal energy balance, i.e., stable capacitor voltage.

### Embodiment 2

A three feeder interconnection system, which achieves flexible interconnectivity through a series-parallel multi-port flexible interconnection device, is illustrated in FIG. 14. The control method in Embodiment 2 is illustrated in FIGS. 6-8. The series-parallel multi-port flexible interconnection device comprises three half-bridge inverters, the three half-bridge inverters connected to AC feeders control the active power and reactive power on feeders 2 and 3, and the corresponding control loop is a line power flow control loop. A bipolar output inverter is directly connected to a common connection bus, the voltage balance of the common connection bus is achieved by injecting a DC circulating current through an output DC component, and the corresponding control loop is a common connection bus voltage balance control loop. The bipolar output inverter compensates for the reactive power on feeder 1, and the corresponding control loop is a bipolar output inverter control loop.

In a distribution method for the power flow regulation equivalent voltage on a distribution feeder of the series-parallel multi-port flexible interconnection device in Embodiment 2, the optimization objective is to minimize the amplitude of the AC component of the output voltage required by the half-bridge inverter, which means that \vec{V}_{C1} is selected such that max{|\vec{V}_{C1}|, |\vec{V}_{C2}|, |\vec{V}_{C3}|} achieves a minimum value.

The simulated operating conditions are as follows: Node 1 generates 0.6 p.u. reactive power, Node 2 generates 0.6 p.u. active power and 0.4 p.u. reactive power, and Node 3 generates 0.2 p.u. active power and 0.2 p.u. reactive power.

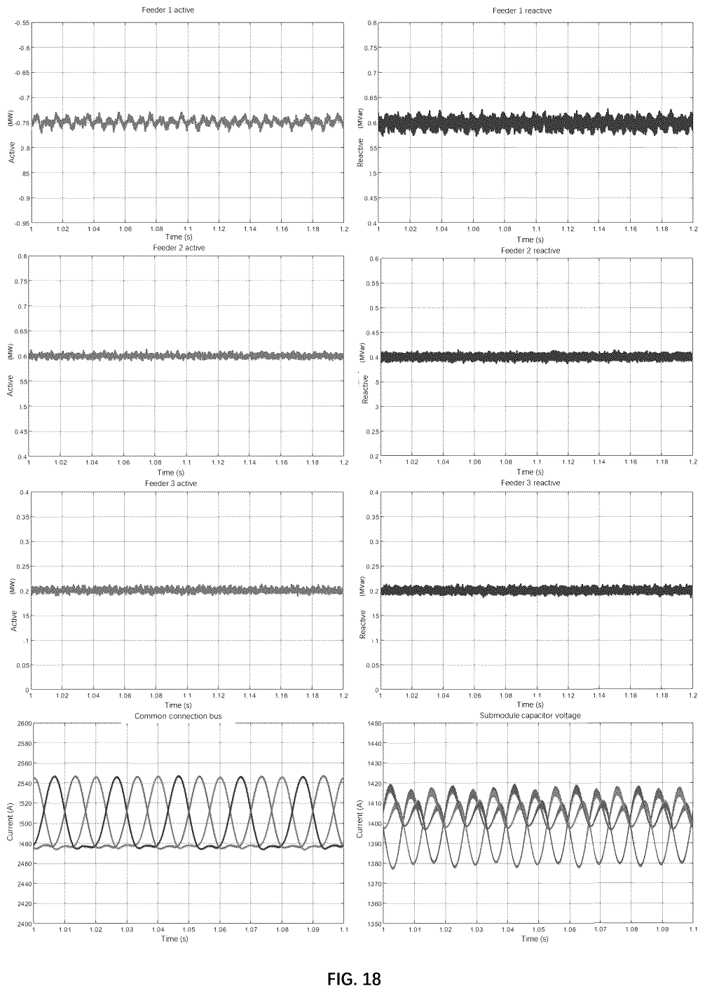

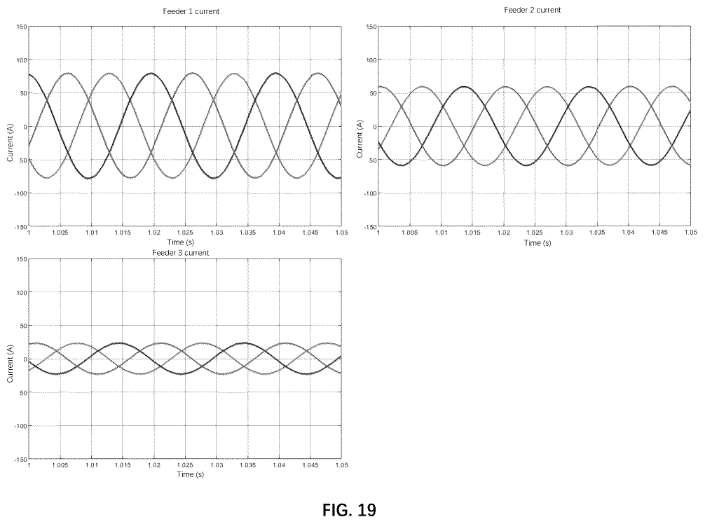

FIGS. 18 and 19 show the simulation results for the operating condition, including eleven waveform graphs in total. Shown from left to right and top to bottom are: feeder 1 active power P₁ waveform graph, feeder 1 reactive power Q₁ waveform graph, feeder 2 active power P₂ waveform graph, feeder 2 reactive power Q₂ waveform graph, feeder 3 active power P₃ waveform graph, feeder 3 reactive power Q₃ waveform graph, three-phase common connection bus voltage Vlink_abc waveform graph, three-phase bipolar output inverter submodule capacitor voltage VCHB_capacitor_abc waveform graph, feeder 1 three-phase current I1abc waveform graph, feeder 2 three-phase current I2abc waveform graph, and feeder 3 three-phase current I3abc waveform graph.

The simulation waveform results indicate that the series-parallel multi-port flexible interconnection device, when interconnecting three feeders, achieves active power flow control with decoupling of active power and reactive power on the interconnected feeders while maintaining internal energy balance, i.e., stable capacitor voltage, and demonstrates the capability for port expansion.

It is important to note that the configuration and arrangement of the present application shown in various exemplary embodiments are merely exemplary. Although only a few embodiments have been described in detail in this disclosure, those who refer to this disclosure will easily understand that many modifications are possible (for example, changes in the dimensions, scales, structures, shapes and proportions of various elements, as well as parameter values (e.g., temperature, pressure, etc.), installation arrangement, use of materials, color and orientation) without materially departing from the novel teachings and advantages of the subject matter described in this application. For example, an element shown as being integrally formed may be composed of multiple parts or elements, the position of the elements may be inverted or otherwise changed, and the nature or number or position of discrete elements may be modified or changed. Therefore, all such modifications are intended to be included within the scope of the present invention. The order or sequence of any process or method steps may be changed or reordered according to alternative embodiments. In the claims, any “means-plus-function” clause is intended to cover the structure described herein that performs the stated function, not just structural equivalents but also equivalent structures. Other substitutions, modifications, changes and omissions may be made in the design, operating conditions and arrangement of the exemplary embodiments without departing from the scope of the present invention. Therefore, the present invention is not limited to specific embodiments, but extends to various modifications that still fall within the scope of the appended claims.

Additionally, to provide a concise description of the exemplary embodiments, not all features of the actual embodiments may be described (i.e., those features that are not relevant to the best mode of carrying out the invention currently under consideration or those features that are not related to the implementation of the invention).

It should be understood that during the development of any actual embodiment, as in any engineering or design project, a multitude of specific implementation decisions may be made. Such development efforts can be complex and time-consuming; however, for those skilled in the art benefiting from this disclosure, it is expected that such development efforts will involve routine work in design, manufacturing, and production without requiring excessive experimentation.

It should be noted that the above embodiments are provided to illustrate the technical scheme of the present invention and are not intended to limit them. Although the present invention has been described in detail with reference to preferred embodiments, those skilled in the art should understand that modifications or equivalent substitutions can be made to the technical scheme of the present invention without departing from the spirit and scope of the technical scheme of the invention, all of which should be included within the scope of the claims of the present invention. It should be noted that the above embodiments are provided to illustrate the technical scheme of the present invention and are not intended to limit them. Although the present invention has been described in detail with reference to preferred embodiments, those skilled in the art should understand that modifications or equivalent substitutions can be made to the technical scheme of the present invention without departing from the spirit and scope of the technical scheme of the invention, all of which should be included within the scope of the claims of the present invention.

It should be understood by those skilled in the art that the embodiments of the application can be provided as methods, systems, or computer program products. Therefore, the application may take the form of an entirely hardware embodiment, an entirely software embodiment, or an embodiment combining software and hardware aspects. Furthermore, the application may take the form of a computer program product implemented on one or more computer usable storage media (including but not limited to magnetic disk memory, CD-ROM, optical memory, etc.) having computer usable program code embodied therein. The schemes in the embodiments of the application can be implemented in various computer languages, such as object-oriented programming language Java and interpreted scripting language JavaScript.

The application is described with reference to flowcharts and/or block diagrams of methods, equipment (systems), and computer program products according to the embodiments of the application. It should be understood that each flow and/or block in the flowchart and/or block diagram, and combinations of flows and/or blocks in the flowchart and/or block diagram can be implemented by computer program instructions. These computer program instructions may be provided to a processor of a general purpose computer, special purpose computer, embedded processor, or other programmable data processing equipment to produce a machine, such that the instructions executed by the processor of the computer or other programmable data processing equipment produce a device for implementing the functions specified in one or more flows in the flowcharts and/or one or more blocks in the block diagrams.

These computer program instructions may also be stored in a computer-readable memory which can direct a computer or other programmable data processing apparatus to function in a particular manner, such that the instructions stored in the computer-readable memory produce an article of manufacture including an instruction device which implements the functions specified in one or more flows in the flowcharts and/or one or more blocks in the block diagrams.

These computer program instructions may also be loaded onto a computer or other programmable data processing apparatus such that a series of operational steps are performed on the computer or other programmable apparatus to produce a computer implemented process, such that the instructions executed on the computer or other programmable apparatus provide steps for implementing the functions specified in one or more flows in the flowcharts/or one or more blocks in the block diagrams.

Although the preferred embodiments of the application have been described, those skilled in the art can make additional changes and modifications to these embodiments once they know the basic inventive concepts. Therefore, the appended claims are intended to be interpreted as including the preferred embodiment and all changes and modifications that fall within the scope of the application.

Obviously, various modifications and variations can be made to this application by those skilled in the art without departing from the spirit and scope of this application. Thus, the application is also intended to comprise such modifications and variations if they fall within the scope of the claims of the application and their equivalents.

What is claimed is:

1. A series-parallel multi-port flexible interconnection device with active power flow control capability for distribution networks, comprising:
a bipolar output inverter and a multi-port flexible interconnection module connected in series therewith, wherein the bipolar output inverter comprises bipolar output voltage and reactive power interchangeability to absorb reactive power from a system or provide reactive power to the system;
the multi-port flexible interconnection module comprises a plurality of unipolar output inverters, wherein the plurality of unipolar output inverters share an identical common connection bus and are connected in parallel, AC output ports of the unipolar output inverters are interconnected with feeders, and by adjusting amplitude and phase of an AC output port voltage of the unipolar output inverters connected in series between the feeders, active control of active and reactive power of the feeders is achieved; and an AC component of the AC output port voltage of the unipolar output inverters connected in series between the feeders is defined as a power flow regulation equivalent voltage, and the multi-port flexible interconnection module is defined as a power flow regulation module.

2. The series-parallel multi-port flexible interconnection device with the active power flow control capability for the distribution networks according to claim 1, wherein the power flow regulation module comprises a second unipolar output inverter connected in parallel with the unipolar output inverters, and the second unipolar output inverter enables a connection between the bipolar output inverter and feeder-side unipolar output inverters; and
by adjusting frequency, amplitude, and phase of an AC output port voltage of the second unipolar output inverter, circulating current is injected into the bipolar output inverter, stabilizing a voltage of the common connection bus of the power flow regulation module.

3. The series-parallel multi-port flexible interconnection device with the active power flow control capability for the distribution networks according to claim 1, wherein a topology of the unipolar output inverter or the second unipolar output inverter in the power flow regulation module is a two-level half-bridge inverter, a three-level half-bridge inverter, or any other unipolar output inverter allowing for bidirectional power flow, or a modular multilevel single-phase current converter.

4. The series-parallel multi-port flexible interconnection device with the active power flow control capability for the distribution networks according to claim 1, wherein a topology of the bipolar output inverter is a two-level full-bridge inverter, a three-level full-bridge inverter, or any other bipolar output inverter allowing for bidirectional power flow, or a cascaded bipolar output inverter with submodules employing two-level or three-level full-bridge topologies.

5. A control method of the series-parallel multi-port flexible interconnection device according to claim 1, comprising: a line power flow control loop, a bipolar output inverter control loop, and a common connection bus voltage balance control loop, wherein
in response to the series-parallel multi-port flexible interconnection device being interconnected with a plurality of feeders, an active power magnitude of one and only one feeder is determined by active power balance requirements of a system, only a reactive power magnitude of the feeder needs to be controlled, and the feeder is referred to as a constant reactive power control feeder; for the other feeders, both active power and reactive power need to be controlled, referred to as power flow control feeders; and
a phase-locked loop locks onto a three-phase phase voltage at nodes of the constant reactive power control feeder, and a phase angle output from the phase-locked loop provides an angle for a Park's transformation matrix from an abc coordinate system to a dq coordinate system.

6. The control method of the series-parallel multi-port flexible interconnection device according to claim 5, wherein a control objective of the line power flow control loop is to ensure that the active power of the power flow control feeder reaches a reference value
$${P}_{j}^{*}$$
and the reactive power reaches a reference value
$${Q}_{j}^{*} ;$$
a control objective of the bipolar output inverter control loop is to ensure that the reactive power of the constant reactive power control feeder reaches a reference value
$${Q}_{i}^{*}$$
and a sum of three-phase capacitor voltages of the bipolar output inverter is stabilized at a reference value
$$\sum {V}_{SM}^{*} ,$$
and an output thereof is a reference value
$${\vec{V}}_{p}^{*}$$
of an AC component of a voltage at an AC output port of the bipolar output inverter; and
a control objective of the common connection bus voltage balance control loop is to stabilize three-phase common connection bus voltages at a reference value
$${V}_{link}^{*} .$$

7. The control method of the series-parallel multi-port flexible interconnection device according to claim 6, wherein an output of the line power flow control loop is
$$Δ {\vec{V}}_{ij}^{*} = {\vec{V}}_{Ci}^{*} - {\vec{V}}_{Cj}^{*}$$
wherein
$${\vec{V}}_{Ci}^{*}$$
is a reference value of an AC component of an output voltage at an AC output port of the unipolar output inverter connected to the constant reactive power control feeder,
$${\vec{V}}_{Cj}^{*}$$
is a reference value of an AC component of an output voltage at an AC output port of the unipolar output inverter connected to the power flow control feeder, the subscript i indicates an i^{th} feeder as the constant reactive power control feeder, and the subscript j denotes a j^{th} power flow control feeder.

8. The control method of the series-parallel multi-port flexible interconnection device according to claim 7, wherein the bipolar output inverter control loop consists of a voltage control outer loop, a reactive power control outer loop, and a current control inner loop.

9. A control method for balancing phase-to-phase voltages of the bipolar output inverter in the series-parallel multi-port flexible interconnection device according to claim 1, comprising a calculation equation for an offset
$$Δ {V}_{dck}^{*}$$
of DC components of outputs of each phase of the bipolar output inverter,
$$\{ \begin{matrix}Δ {V}_{dck}^{*} = {k}_{p 6} ( {I}_{pd}^{*} - {I}_{pdk}^{*} ) + {k}_{i 6} \int ( {I}_{pd}^{*} - {I}_{pdk}^{*} ) dt \\ {I}_{pdk}^{*} = {k}_{p 7} ( \sum {V}_{SM}^{*} / 3 - \sum {V}_{SMk} ) + {k}_{i 7} \int ( \sum {V}_{SM}^{*} / 3 - \sum {V}_{SMk} ) dt\end{matrix}$$
wherein
$${I}_{pdk}^{*}$$
is a reference value of a d-axis component of an AC component of a k-phase current in the bipolar output inverter, Σ^{V}_{SML} is an instantaneous value of a sum of capacitor voltages of phase k of the bipolar output inverter, kₚ₆, kₚ₇ is a gain coefficient of a proportional part of a proportional-integral controller, and kᵢ₆, kᵢ₇ is a gain coefficient of an integral part of the proportional-integral controller.

10. The control method for balancing the phase-to-phase voltages of the bipolar output inverter in the series-parallel multi-port flexible interconnection device according to claim 9, wherein the control method comprises: adjusting the DC components of the outputs of each phase of the bipolar output inverter based on a deviation of a sum of capacitor voltages in submodules of each phase of the bipolar output inverter, and controlling an active power exchange of each phase of the bipolar output inverter without affecting a voltage balance of a bus capacitor in the power flow regulation module, wherein consistency in the phase-to-phase voltages of the bipolar output inverter is achieved.

11. A distribution method for the AC output port voltage of the unipolar output inverters in the series-parallel multi-port flexible interconnection device according to claim 1, wherein the distribution method satisfies the following basic condition equations:
$$\{ \begin{matrix}{\vec{V}}_{C 1} - {\vec{V}}_{Ck} = Δ {\vec{V}}_{1 k} ( k = 2 , 3 , … , n ) \\ Real ( {\sum }_{k = 1}^{n} {\vec{V}}_{Ck} \cdot {\vec{I}}_{k}^{*} - {V}_{link} {I}_{cir} ) = 0\end{matrix}$$
wherein a first feeder is designated as a constant reactive power control feeder, \vec{V}_{Ck} is a vector expression for an AC component of the AC output port voltage of the unipolar output inverter on a k^{th} feeder of the series-parallel multi-port flexible interconnection device, Δ\vec{V}ₗₖ is an expression for a power flow regulation equivalent voltage to be inserted in series between the first feeder and a k^{th} feeder, in order to attain a desired power flow on the k^{th} feeder,
$${\vec{I}}_{k}^{*}$$
is a conjugate vector expression of an AC on the k^{th} feeder, and n is a number of feeders interconnected through the series-parallel multi-port flexible interconnection device; and
the series-parallel multi-port flexible interconnection device with the active power flow control capability for AC grids distributes the AC output port voltage of the unipolar output inverter on a distribution feeder according to any set of solutions to {\vec{V}_{Ck} (k=1, 2, . . . , n)} satisfying the basic condition equations.

12. The distribution method for the AC output port voltage of the unipolar output inverters in the series-parallel multi-port flexible interconnection device according to claim 11, wherein the distribution method comprises: satisfying \vec{V}_{C1}=Δ\vec{V}ₗₖ/2(k=2, 3, . . . , n).

13. The distribution method for the AC output port voltage of the unipolar output inverters in the series-parallel multi-port flexible interconnection device according to claim 12, wherein the distribution method comprises: minimizing
$$Real ( {\sum }_{k = 1}^{n} {\vec{V}}_{Ck} \cdot {\vec{I}}_{k}^{*} ) ,$$
meaning a selection of \vec{V}_{C1} fulfills a criterion of minimal
$$Real ( {\sum }_{k = 1}^{n} {\vec{V}}_{Ck} \cdot {\vec{I}}_{k}^{*} ) .$$

14. The distribution method for the AC output port voltage of the unipolar output inverters in the series-parallel multi-port flexible interconnection device according to claim 13, wherein the distribution method comprises: selecting \vec{V}_{C1}, wherein max{|\vec{V}_{Ck}|(k=1, 2, . . . , n)} achieves a minimum value.

15. The distribution method for the AC output port voltage of the unipolar output inverters in the series-parallel multi-port flexible interconnection device according to claim 14, wherein the distribution method further comprises any selection approach-satisfying the basic condition equations.

16. A starting method of the series-parallel multi-port flexible interconnection device according to claim 1, comprising three stages, wherein
the first stage is an uncontrolled rectification stage, where grid connection is established after a current-limiting resistor is placed in series with the AC output port, switches are locked, and an uncontrolled rectification circuit formed by diodes charges capacitors within the series-parallel multi-port flexible interconnection device;
the second stage is a controlled rectification stage, where after a charging in the first stage is completed, the capacitors are alternately connected to or disconnected from a charging circuit in such a way that a total number of capacitors in the charging circuit remains constant, charging a voltage of the capacitors within the series-parallel multi-port flexible interconnection device to near a rated value; and
the third stage is a ramp-up voltage boosting stage, wherein after a charging in the second stage is completed, the current-limiting resistor is removed, and by applying a ramp-up reference voltage, a voltage control loop is utilized to charge a capacitor voltage to the rated value, the voltage control loop comprising a common connection bus voltage balance control loop and a voltage control outer loop of a bipolar output inverter control loop.

17. A protection method of the series-parallel multi-port flexible interconnection device according to claim 1 in an event of feeder faults, comprising:
after AC feeder area protection completes an identification of faulty feeders and fault points, sending a tripping signal to the series-parallel multi-port flexible interconnection device;
locking switches, and after dead time protection, triggering a thyristor bypass switch of the power flow regulation module to cut off a power interchanging channel between the feeder and the common connection bus, wherein the power flow regulation module is protected; and
making a circuit breaker at an outlet of a corresponding port of the series-parallel multi-port flexible interconnection device trip to disconnect from the faulty feeders, and depending on whether voltages of common connection bus capacitors and DC-side capacitors of the bipolar output inverter exceed a set value, deciding whether to connect or disconnect a DC load shedding circuit to maintain DC voltages of parts within a safe range.

18. The protection method of the series-parallel multi-port flexible interconnection device in the event of feeder faults according to claim 17, further comprising:
equipping a lower bridge arm of each unipolar output inverter with a thyristor bypass switch connected in parallel thereto, the thyristor bypass switch consists of two thyristors connected in reverse parallel and an inductor in series, allowing for rapid bypassing of the unipolar output inverter, and clamping a voltage in series on the feeder to approximately 0 V.

19. The protection method of the series-parallel multi-port flexible interconnection device in the event of feeder faults according to claim 18, further comprising:
connecting the common connection bus capacitors and the DC-side capacitors of the bipolar output inverter in parallel to the DC load shedding circuit for a release of bus energy.

20. A control system of the series-parallel multi-port flexible interconnection device according to claim 1, wherein the control system adopts a centralized control framework, wherein a line power flow control loop, a bipolar output inverter control loop, and a common connection bus voltage balance control loop are integrated within a single controller.

21. The control system of the series-parallel multi-port flexible interconnection device according to claim 20, wherein the control system adopts a distributed control framework, achieving control through a plurality of controllers of an identical level, with no communication between the plurality of controllers of the identical level.

22. The control system of the series-parallel multi-port flexible interconnection device according to claim 21, wherein the control system adopts a hierarchical control framework combining centralized and distributed control, achieving control through a plurality of controllers of different levels, with information communication between the plurality of controllers of the different levels and no communication between the plurality of controllers of the identical level.

23. The control system of the series-parallel multi-port flexible interconnection device according to claim 22, wherein the controllers are hardware equipment allowed for performing control loop functions.
